(19) United States
(12) Patent Application Publication
(10) Pub. No.: US 2004/0085933 A1
(43) Pub. Date: May 6, 2004

(54) Satellite antenna system employing electronic elevation control for signal acquisition and tracking

(75) Inventor: James June-Ming Wang, San Marino, CA (US)

Correspondence Address: David P. Gordon, Esq., 65 Woods End Road, Stamford, CT, 06905, US

(73) Assignee: TIA Mobile, Inc.

(21) Appl. No.: 10/287,371

(22) Filed: Nov. 4, 2002

(51) Int. Cl. H04J 1/10

(52) U.S. Cl. 370/334

(57) ABSTRACT

An improved satellite receiver includes a phased array antenna subsystem with a local oscillator that produces a local oscillating signal and delay means that introduces different phased delays to the local oscillating signal to produce a plurality of oscillating waveform signals with different phase delays. These oscillating waveform signals are supplied to downconverting mixers in the processing channels of the phased array antenna subsystem. A controller electronically adjusts an elevation angle pointing direction of the satellite receiver by varying frequency of the local oscillating signal produced by the local oscillator. Such electronic elevation pointing direction control is preferably performed as part of an antenna position initialization routine that scans over large elevation angle pointing directions (via updates to the frequency of the local oscillating signal) to lock onto position of the transmitting satellite and/or part of a signal tracking routine that maximizes received signal strength of a particular received signal. In addition, the controller varies frequency of the local oscillating signal in response to user channel selection information communicated thereto.

### BACKGROUND OF THE INVENTION

1. Field of the Invention

This invention relates broadly to phased array communication systems, and more particularly, this invention relates to phased array communication systems suitable for use in digital broadcast satellite (DBS) systems.

2. State of the Art

Phased array communication systems (sometimes referred to as phased array antenna systems) have been predominantly used in military and aerospace applications because of their high implementation costs. FIGS. 1A and 1B show a typical implementation of a prior art phased array communication system.

FIG. 1A illustrates a receiving phased array communication system 10 including a number of antenna elements 11-1, 11-2 . . . 11-N. The signal from each antenna element is supplied to a number of components (referred to below as a processing channel) that operate on the signal produced by the given antenna element as follows. In a given processing channel x (where x identifies any one of the N processing channels shown), the antenna signal is amplified, filtered and downconverted into a lower frequency by an amplifier 13-x, filter 15-x, and downconverting mixer 17-x, respectively. The lower frequency signal produced by the downconverting mixer 17-x is filtered by a filter 19-x and then subjected to amplification and phase shift by an analog-type variable gain amplifier 21-x and variable phase shifter 23-x, respectively. The resultant signal produced by each of the N processing channels is then combined by a summing amplifier 25 to produce a combined signal that is output to signal analysis circuitry for subsequent processing (which typically involves demodulation and decoding that extracts information contained in the combined signal produced by the summing amplifier 25).

FIG. 1B illustrates a transmitting phased array communication system 30. A transmit signal, which is typically a modulated signal produced by a transmit signal source as shown, is provided by a splitter 31 to a number of processing channels that operate on the transmit signal supplied thereto. Each processing channel includes a number of components that operate on the transmit signal supplied thereto as follows. In a given processing channel x (where x identifies any one of the N processing channels shown), the transmit signal is subjected to amplification and a phase shift by an analog-type variable gain amplifier 33-x and variable phase shifter 35-x, respectively, and then filtered by filter 37-x. The resultant signal is upconverted to a higher frequency, filtered and amplified by upconverting mixer 39-x, filter 41-x, and amplifier 43-x, respectively. The resultant signal produced by the amplifier 43-x is supplied to the corresponding antenna element 11-x for transmission.

An antenna pattern for the combined receive signal/transmit signal can be formed by a set of specific gain values and phase shift values for the variable gain amplifiers and the variable phase shifters over the N processing channels and a specific geometry and placement of the N antenna elements. The set of specific gain values and phase shift values is commonly referred to as “weights” (or “weight vector”) for the phased array communication system.

A unique advantage of the phased array communication system is that the antenna pattern can be adjusted by changing the “weights” as described above to perform one (or any combination) of the following operations:

a) beam steering: steering the beam by adjusting the phase shift values of the pattern for each processing channel; no adjustment to the gain values of the pattern is necessary.

b) antenna null: the phase shift values and gain values of the pattern are adjusted to the suppress signal (i.e., interference) from a specific direction.

c) multiple antenna beams: the signal before the variable gain amplifier and phase shifter in each processing channel is split into multiple copies wherein each copy passes through its own variable gain amplifier and phase shifter; this enables the same antenna element to be used to receive or transmit signals in multiple directions simultaneously.

Although such configurations provide for improved performance, they suffer from problems that stem from the use of the variable gain amplifier and variable phase shifter. More specifically, these components are complicated and expensive and are subject to problems such as component tolerance and drift due to temperature variations and aging. In addition, the signal delay in each processing channel must be precise in order to generate accurate beam steering. This is difficult to achieve if the number of signal processing elements in the processing channel is large or the electrical connections between such elements are long. Moreover, in the event that signal delay through the processing elements in each processing channel cannot be precisely maintained, a calibration procedure which measures the signal delays in each processing channel and compensations for such signal delays is required. Such a calibration procedure may limit the suitability of the phased array system for many applications (such as consumer applications) that require limited maintenance by the end user.

FIGS. 2A and 2B illustrate a prior art phased array communication system employing a digital beam forming mechanism. This system operates similar to the phased array system described above with respect to FIGS. 1A and 1B. In the receiving phased array communication system of FIG. 2A, the analog-type variable gain amplifier and variable phase shifter in each processing channel of FIG. 1A is replaced by high-speed analog-to-digital converter 22-x and digital complex multiplier 24-x, and the summing amplifier 25 is replaced by adders 26 that produce a combined signal (in digital form). In the transmitting phased array communication system of FIG. 2B, the splitter and the analog-type variable gain amplifier and variable phase shifter in each processing channel of FIG. 1A is replaced by a digital splitter 32 that provides a copy of the transmit signal (in digital form) to a digital complex multiplier 34-x and high speed digital-to-analog converter 36-x in each processing channel. In both the receiving and transmitting phased array communication system, the antenna pattern is formed by the geometric arrangement of the antenna elements and the variable gain and variable phase delay over the processing channels as controlled by the set of complex weights (w₀ . . . w_{M}) supplied to the digital complex 21 multipliers 24-1 . . . 24-N and 34-1 . . . 34-N.

The digital beam forming mechanism of FIGS. 2A and 2B eliminates some of the implementation issues of the analog-type variable gain amplifier and variable phase shifter as described above, yet adds costs associated with multiple converters and digital circuits. In addition, one of the drawbacks of this implementation is that the level of the input signal to the analog-to-digital converters 22-1 . . . 22-N needs to be at a substantially higher level as compared to that of the received signal at the antenna elements 11-1 . . . 11-N. Thus, the received signal needs to be amplified by one or more amplification stages to bring the received signals to a level upon which the analog-to-digital converters 22-1 . . . 22-N can effectively operate. Moreover, in this implementation, it is difficult to maintain precise signal delays through the processing channels because the number of processing elements are large. Thus, calibration might also be required, which limits the applications of such phased array communication systems.

FIGS. 3A and 3B illustrate a prior art phased array communication system employing a code division multiplexed (CDM) beam forming mechanism. The analog-type CDM multiplexing circuitry of the receiving phased array communication system of

FIG. 3A is described in detail in U.S. Pat. No. 5,077,562.

In the receiving phased array communication system of FIG. 3A, the signal received at each antenna 11-x is amplified and filtered by amplifier 13-x and filter 15-x, and the resultant signals are modulated with unique high speed codes (from a set of orthogonal codes) and combined by analog CDM multiplexing circuitry 49 as shown. The composite signal produced by the analog CDM multiplexing circuitry 49 is downconverted to a lower frequency by downconverting mixer 17′ and filtered by filter 19′. The resultant signal is supplied to a high speed analog-to-digital converter 22′. The digital words output by converter 22′ are supplied to digital CDM demultiplexing logic 52 which removes the effects of code modulation by multiplying (bi-phase multiplying) the signal with the same code in precise timing alignment with the original code, thereby extracting components in the digital words supplied thereto that correspond to the signals received at the array elements. The digital CDM demultiplexing logic supplies the extracted components to a digital beam forming mechanism which includes digital complex multiplier 24-x in each processing channel and an adder 26 that adds the signals output from the multipliers 24-1 . . . 24-N to produce a combined signal in digital form. In the receiving phased array communication system of FIG. 3A, the antenna pattern is formed by the geometric arrangement of the antenna elements and the variable gain and variable phase delay over the processing channels as controlled by the set of complex weights (W₀ . . . w_{M}) supplied to the digital complex multipliers 24-1 . . . 24-N.

In the transmitting phased array communication system of FIG. 3B, the transmit signal is supplied to a digital beam forming mechanism comprised of a digital splitter 32 and a digital complex multiplier 34-x in each processing channel. The output of the digital complex multipliers 34-1 . . . 34-N are modulated with unique high speed codes (from a set of orthogonal codes) and combined by digital CDM multiplexing logic 54 as shown. The composite signal produced by the digital CDM multiplexing logic is supplied to a high speed digital-to-analog converter 36′, whose output signal is filtered by filter 37′ and then upconverted to a higher frequency by upconverting mixer 39′. The resultant signal produced by upconverting mixer 39′ is supplied to analog CDM demultiplexing circuitry 57 which removes the effects of code modulation by multiplying (bi-phase multiplying) the signal with the same code in precise timing alignment with the original code, thereby extracting the components in the signal supplied thereto that correspond to the signals produced by the digital complex modulators 34-1 . . . 34-N, and supplies each extracted component to a filter 41-x, amplifier 43-x and antenna element 11-x for transmission. In the transmitting phased array communication system of FIG. 3B, the antenna pattern is formed by the geometric arrangement of the antenna elements and the variable gain and variable phase delay over the processing channels as controlled by the set of complex weights (w₀ . . . w_{M}) supplied to the digital complex multipliers 34-1 . . . 34-N.

The architecture of FIG. 3A is advantageous because signal combination occurs very close to the antenna elements. Similarly, the architecture of FIG. 3B is advantageous because signal combination occurs very close to the digital complex multipliers. These advantages eliminate many of the problems of the previous architectures that stem from variations in signal delay through each processing channel. However, these architectures requires that the high speed code modulations must be at a rate equal to the signal bandwidth times the number of antenna elements. Consequently, the converters 22′ and 36′ must operate at an extremely high clock speed. This limitation curtails the applicability of this architecture to applications with lower bandwidth signals or a small number of antenna elements.

Thus, there remains a need in the art for improved phased array communication systems that are cost effective; that provide precise phase delay through the processing channels of the system for accurate beam steering; and that are suitable for applications that require high bandwidth signals, a large number of antenna elements, and/or limited maintenance by the end user.

### SUMMARY OF THE INVENTION

It is therefore an object of the invention to provide an improved phased array communication system that provides precise phase delay through the processing channels of the system for accurate beam steering with minimal costs.

It is another object of the invention to provide an improved phased array communication system that provides precise phase delay through the processing channels of the system for accurate beam steering and that is suitable for applications that require high bandwidth signals.

It is a further object of the invention to provide an improved phased array communication system that provides precise phase delay through the processing channels of the system for accurate beam steering and that is suitable for applications that require a large number of antenna elements.

It is a further object of the invention to provide an improved phased array communication system that provides precise phase delay through the processing channels of the system for accurate beam steering and that is suitable for applications that require limited maintenance by the end user.

It is an additional object of the invention to provide an improved phased array receiving system that provides precise phase delay through the processing channels of the system for accurate beam steering and that minimizes the number of signal processing elements in each processing channel prior to signal combination.

It is an additional object of the invention to provide an improved phased array transmitting system that provides precise phase delay through the processing channels of the system for accurate beam steering and that minimizes the number of signal processing elements in each processing channel after signal splitting.

It is still another object of the invention to provide an improved phased array communication system that provides precise phase delay through the processing channels of the system for accurate beam steering utilizing simple and cost effective components.

It is still a further object of the invention to provide an improved phased array communication system that provides precise phase delay through the processing channels of the system for accurate beam steering utilizing cost effective frequency synthesis components that are readily available in the commercial marketplace.

In accord with these objects, which will be discussed in detail below, an improved receiving phased array communication system is provided that supplies oscillating waveform signals with different phase delays to the downconverting mixers in the processing channels of the receiving phased array communication system to compensate for phase difference in the received signal over the antenna elements therein. Similarly, an improved transmitting phased array communication system is provided that supplies oscillating waveform signals with different phase delays to the upconverting mixers in the processing channel of the transmitting phased array communication system to introduce phase difference in the transmit signal for transmission over the antenna elements therein.

The oscillating waveform signals with different phase delays are preferably derived from a local oscillator that generates a local oscillating signal, and a delay line network having a plurality of fixed delay lines arranged in a serial manner to introduce increasing fixed phase delays in the local oscillating signal. The signal produced by each fixed delay line in the network is output via a corresponding tap in the delay line network to form oscillating waveform signals with increasing phase delays.

It will be appreciated that the improved phased array communication systems described herein are suitable for satellite applications that utilize frequency-divided channels such as Digital Broadcast Satellite (DBS) systems.

Additional objects and advantages of the invention will become apparent to those skilled in the art upon reference to the detailed description taken in conjunction with the provided figures.

### BRIEF DESCRIPTION OF THE DRAWINGS

FIG. 1A is a block diagram of the functional elements of a typical prior art phased array receiving communication system;

FIG. 1B is a block diagram of the functional elements of a typical prior art phased array transmitting communication system;

FIG. 2A is a block diagram of the functional elements of a typical prior art phased array receiving communication system utilizing a digital beam forming mechanism.

FIG. 2B is a block diagram of the functional elements of a typical prior art phased array transmitting communication system utilizing a digital beam forming mechanism.

FIG. 3A is a block diagram of the functional elements of a typical prior art phased array receiving communication system utilizing a code-division-multiplexed beam forming mechanism.

FIG. 3B is a block diagram of the functional elements of a typical prior art phased array transmitting communication system utilizing a code-division-multiplexed beam forming mechanism.

FIG. 4 illustrates a signal incident on a linear row of N equally-spaced-apart antenna elements (1 . . . N) at an incident angle [symbol] , and the signal delay over the antenna elements that results from this incident angle.

FIGS. 5A1 and 5A2 are block diagrams of the functional elements of improved phased array receiving communication systems in accordance with the present invention, to thereby compensate for the signal delays shown in FIG. 4 for beam steering.

FIGS. 5B1 and 5B2 are block diagrams of the functional elements of improved phased array transmitting communication systems in accordance with the present invention, to thereby introduce signal delays shown in FIG. 4 for beam steering. FIGS. 5C1 through 5C3 illustrate three different exemplary embodiments for carrying out signal analysis on the combined signal for use in DBS applications, which demodulate a 30 MHz transponder channel contained in the combined signal and decode and demultiplex MPEG data streams in the 30 MHz transponder channel to produce the original video and sound for a selected channel.

FIG. 6A is a functional block diagram of a local oscillator suitable for use in the phased array communication systems describer herein; the local oscillator uses a phase-locked synthesizer to produce a local oscillating signal whose frequency is controlled by divider ratio(s) provided to the synthesizer.

FIG. 6B is a functional block diagram of the synthesizer of FIG. 6A.

FIG. 7A functional block diagram of a local oscillator suitable for use in the phased array communication systems describer herein; the local oscillator uses a phase-locked synthesizer to produce a local oscillating signal whose frequency is controlled by varying the digital input to a direct digital synthesizer.

FIG. 7B is a functional block of the direct digital synthesizer of FIG. 7A.

FIG. 7C is a functional block diagram of the synthesizer of FIG. 7A.

FIG. 8 illustrates a signal incident on a linear row of N unequally-spaced-apart antenna elements (1 . . . N) at an incident angle [symbol] , and the signal delay over the antenna elements that results from this incident angle.

FIGS. 9A1 and 9A2 are block diagrams of the functional elements of improved phased array receiving communication systems in accordance with the present invention, to thereby compensate for the signal delays shown in FIG. 8 for beam steering.

FIGS. 9B1 and 9B2 are block diagrams of the functional elements of improved phased array transmitting communication systems in accordance with the present invention, to thereby introduce signal delays shown in FIG. 8 for beam steering.

FIG. 10A is a block diagram of the functional elements of the improved two-dimensional phased array receiving communication system in accordance with the present invention.

FIG. 10B is a block diagram of the functional elements of the improved two-dimensional phased array transmitting communication system in accordance with the present invention.

FIG. 11A is a block diagram of the functional elements of the improved multi-beam phased array receiving communication system in accordance with the present invention.

FIG. 11B is a block diagram of the functional elements of the improved multi-beam phased array transmitting communication system in accordance with the present invention.

FIG. 12A is a schematic diagram of a phased array receiving communication system employed a DBS application, wherein the combined signal is retransmitted over a wireless communication link to a DBS receiver in accordance with the present invention.

FIG. 12B is a flow chart illustrating the operations performed-by controller 112 of FIG. 12A in updating the frequency of the oscillating signal produced by the local oscillator (LO) to provide for frequency tuning (in response to user channel selection) in addition to elevation angle adjustment of the phased array receiving communication system in accordance with the present invention.

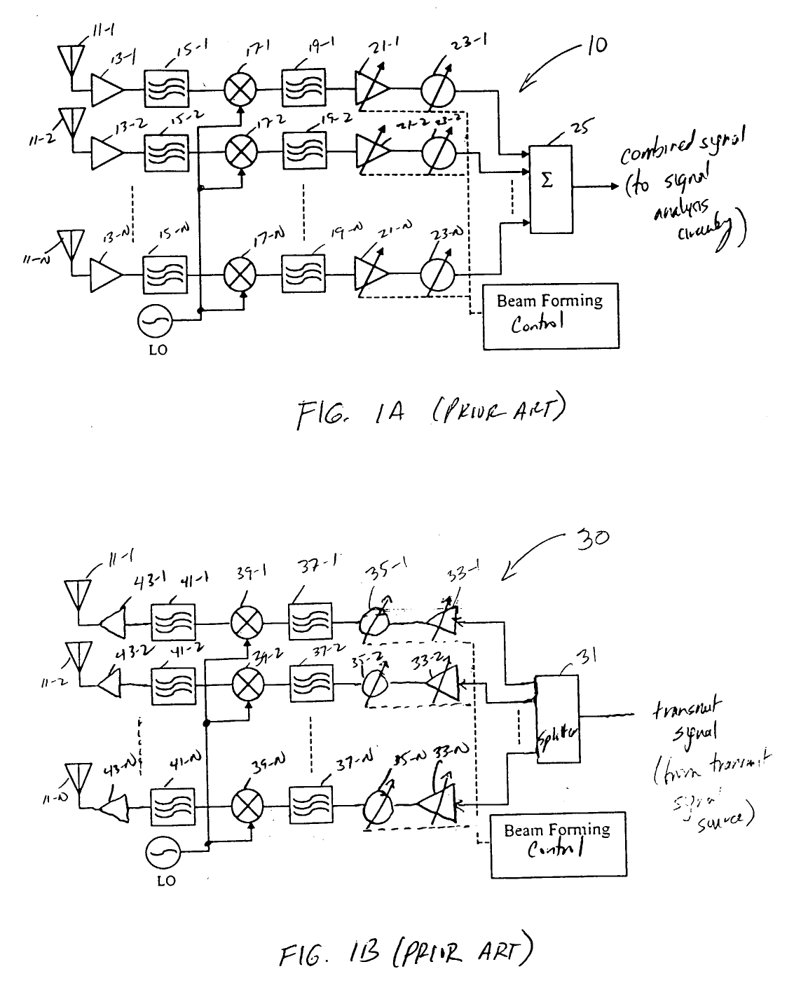

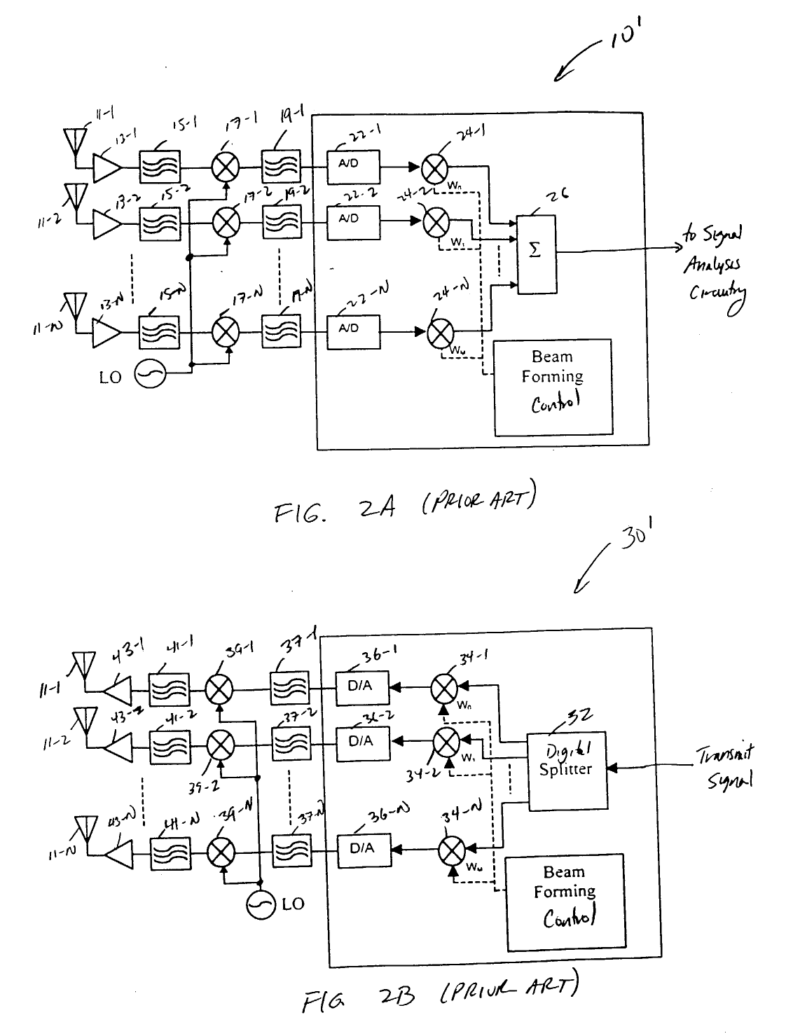

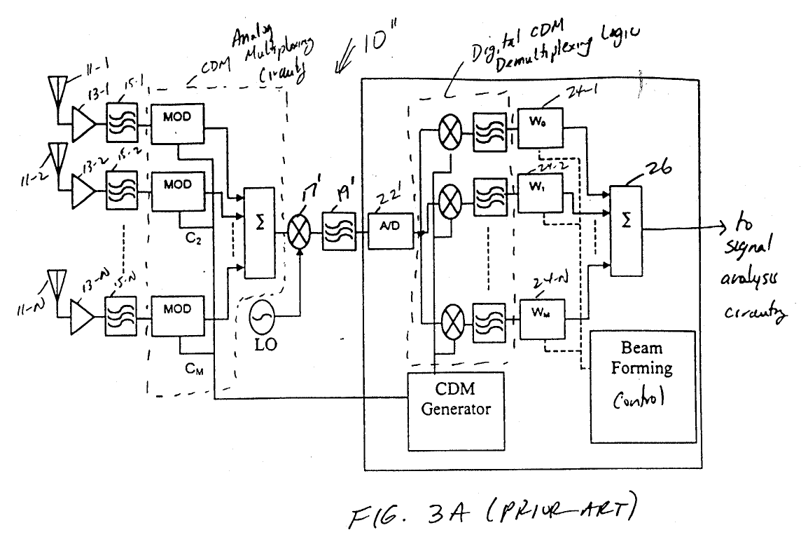

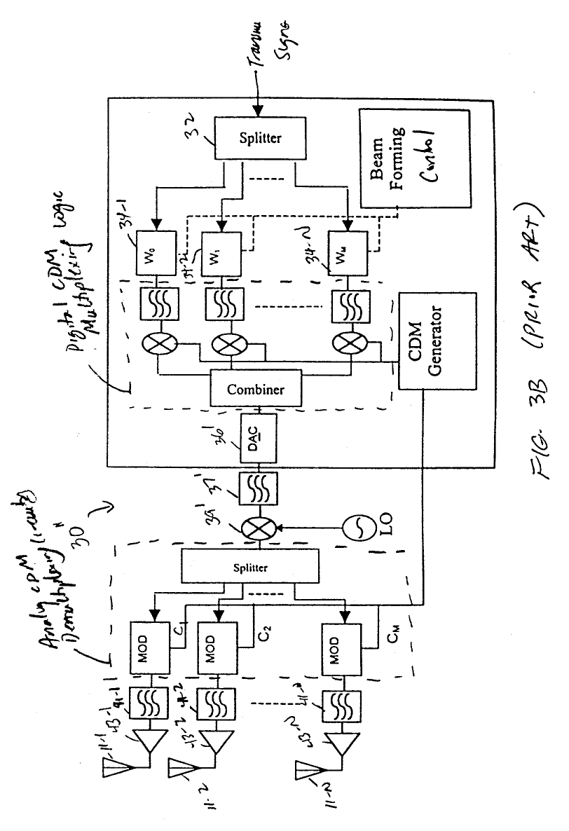

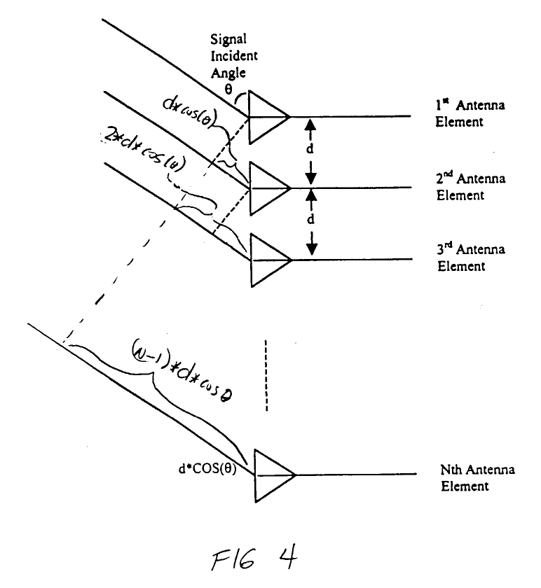

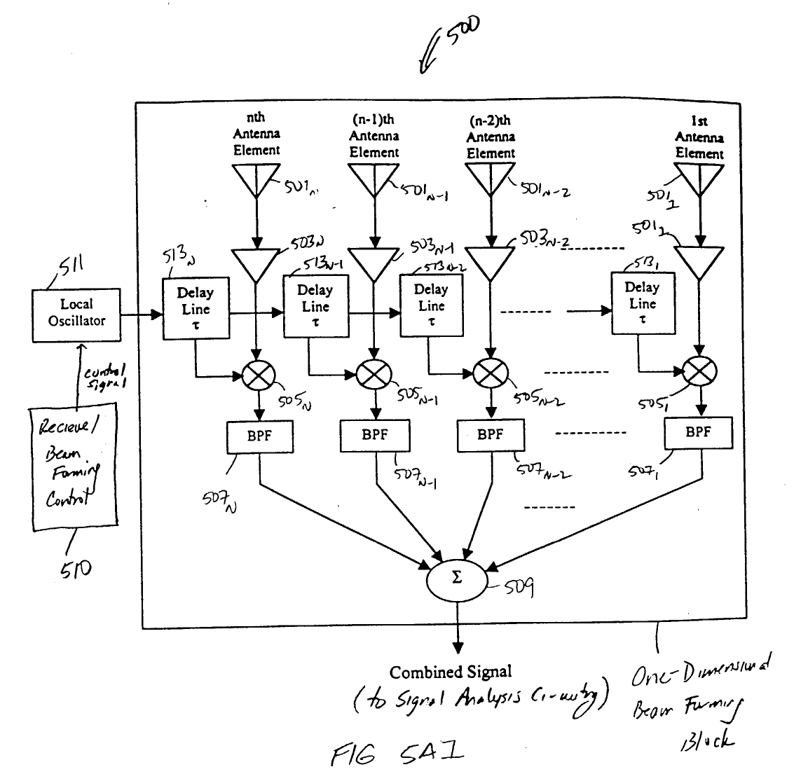

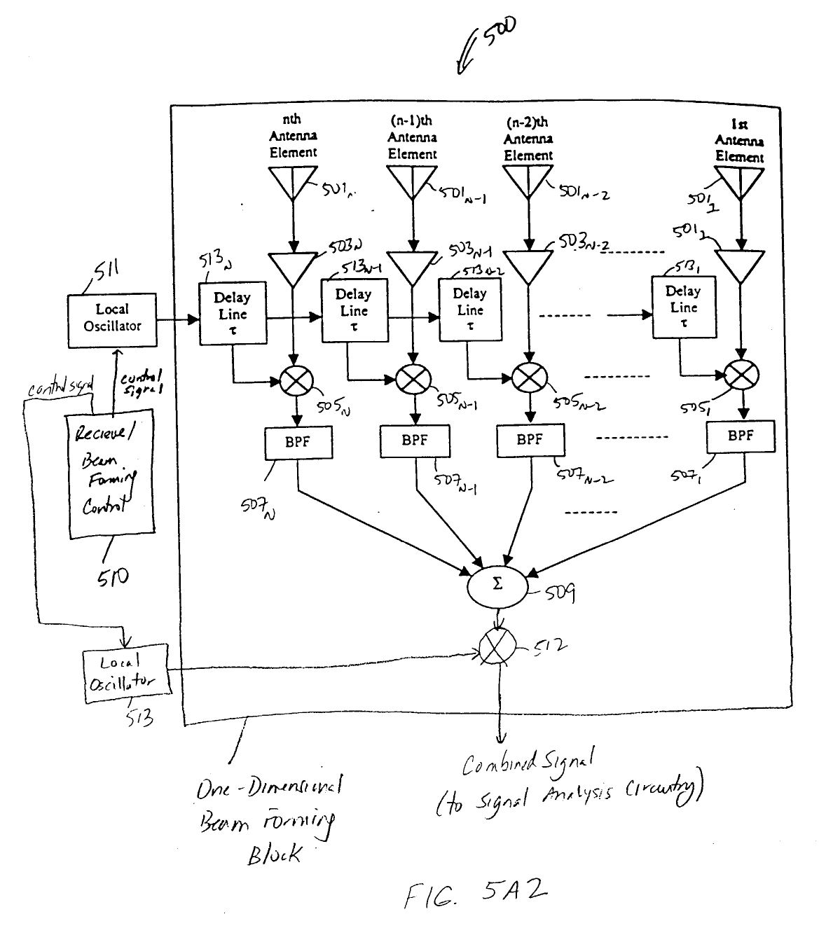

### DETAILED DESCRIPTION OF THE PREFERRED EMBODIMENTS

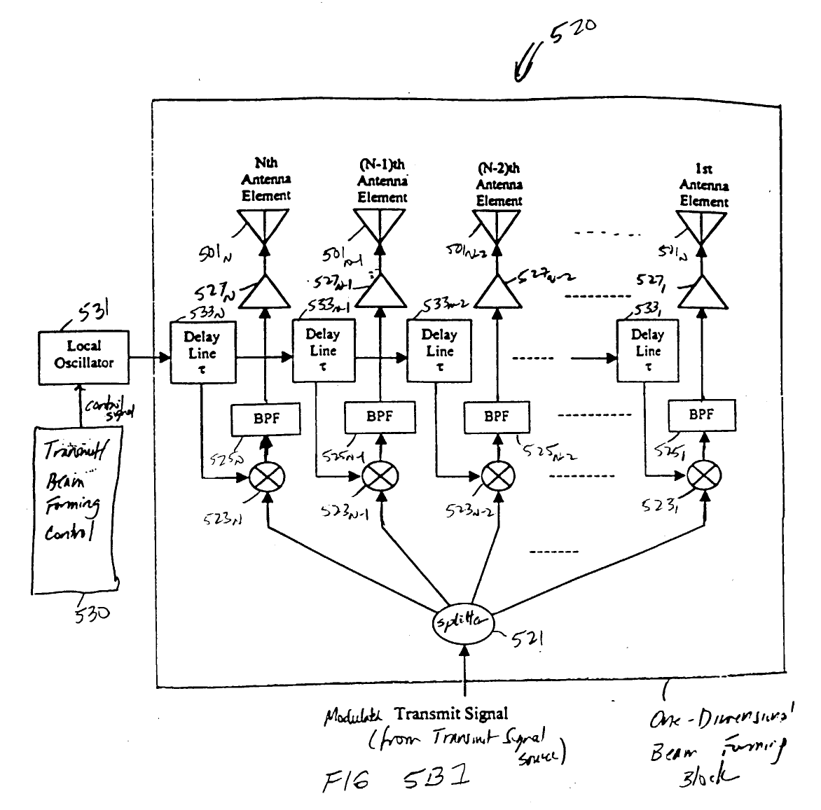

Turning now to FIG. 4, consider a signal incident on a linear row of N antenna elements (1 . . . N) at an incident angle [symbol] . The N antenna elements are equally spaced apart by a distance d in the one-dimension. In this configuration, the signal propagation delay between adjacent antenna elements is given by the expression: d*cos( [symbol] ). Note that the signal propagation delay between the first antenna element and the Xth antenna element (where 2≦X≦N, to thereby identify an arbitrary antenna element from the second antenna element to the Nth antenna element) is given by the expression: (x−1) *d*cos( [symbol] ).

If the incident signal is modulated at carrier frequency f_{c}, the signal propagation delay between adjacent antenna elements of d*cos( [symbol] ) corresponds to a phase difference given by the expression: 2*π*f_{c}*d*cos( [symbol] )/c, where c is the propagation speed of the incident signal. Therefore, the phase delay between the first antenna element and the Xth antenna element is given by the expression: 2*π* f_{c}*(x−1)*d*cos( [symbol] )/c.

Compensation of such phase differences enables the signal from all antenna elements to be combined (summed) with matching phase. This condition is equivalent to pointing the antenna (sometimes referred to herein as pointing or steering the antenna beam) toward the [symbol] direction.

In accordance with the present invention, an improved receiving phased array communication system is provided that supplies oscillating waveform signals with different phase delays to the downconverting mixers in the processing channels of the receiving phased array communication system to compensate for phase difference in the received signal over the antenna elements therein. Similarly, an improved transmitting phased array communication system is provided that supplies oscillating waveform signals with different phase delays to the upconverting mixers in the processing channel of the transmitting phased array communication system to introduce phase difference in the transmit signal for transmission over the antenna elements therein.

The oscillating waveform signals with different phase delays are preferably derived from a local oscillator that generates a local oscillating signal, and a delay line network having a plurality of fixed delay lines (for example, implemented with microstrip traces) arranged in a serial manner to introduce increasing fixed phase delays in the local oscillating signal. The signal produced by each fixed delay line in the network is output via a corresponding tap in the delay line network to form oscillating waveform signals with increasing phase delays. In the receiving phased array communication system, the series of oscillating waveform signals with increased phase delay (which are produced via the series of taps in the delay line network) are supplied to the downconverting mixers in the processing channels of the system to compensate for phase delay in the signal received over the antenna elements of the system. In the transmitting phased array communication system, the series of oscillating waveform signals with increased phase delay (which are produced via the series of taps in the delay line network) are supplied to the upconverting mixers in the processing channels of the system to introduce phase delay in the transmit signal supplied thereto for transmission over the antenna elements of the system.

Advantageously, the improved phased array communication systems of the present invention are cost effective over the prior art architectures in that they avoid the use of costly and problematic analog-type variable gain amplifiers, analog-type variable phase shifters, and/or digital complex multipliers in favor of simple and inexpensive components that introduce phase delay into the oscillating waveforms supplied to the downconverting mixers and/or upconverting mixer in such systems. Moreover, the improved phased array communication systems of the present invention provide precise phase delay through the processing channels of the system for accurate beam steering, and are suitable for applications that require high bandwidth signals and/or a large number of antenna elements. In addition, the improved phased array communication systems of the present invention substantially reduce the need for calibration of the phase delay through the processing channels of the system, and thus are suitable for applications (such as consumer applications) that require limited maintenance by the end user.

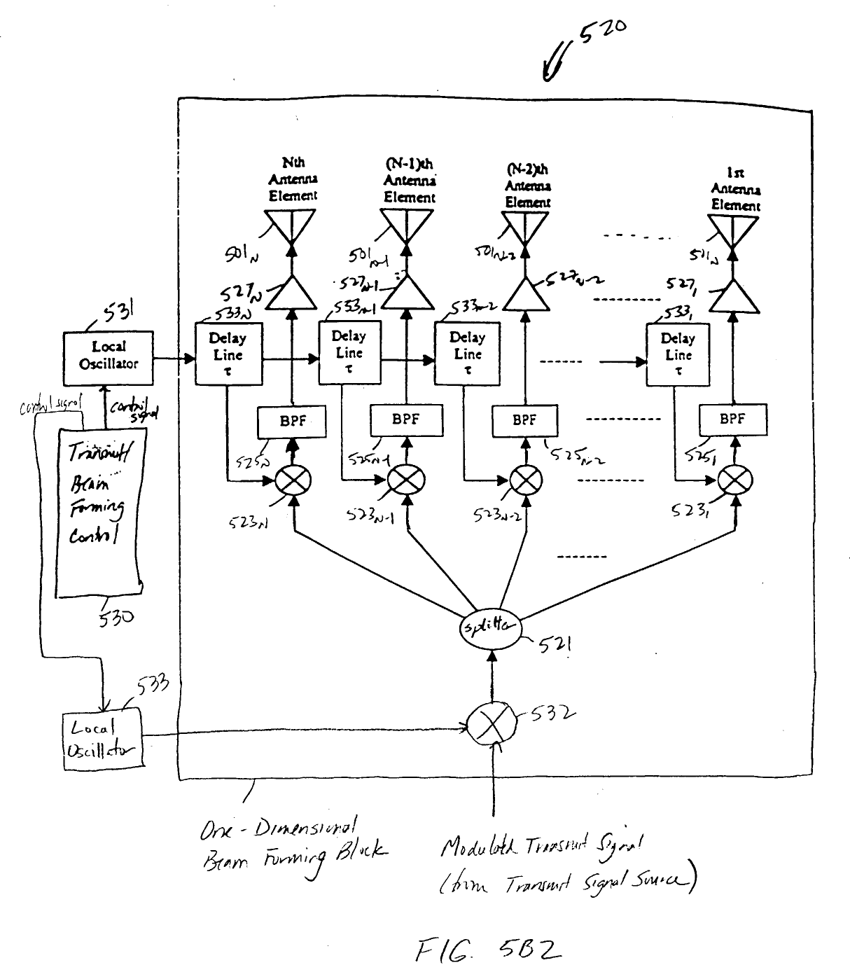

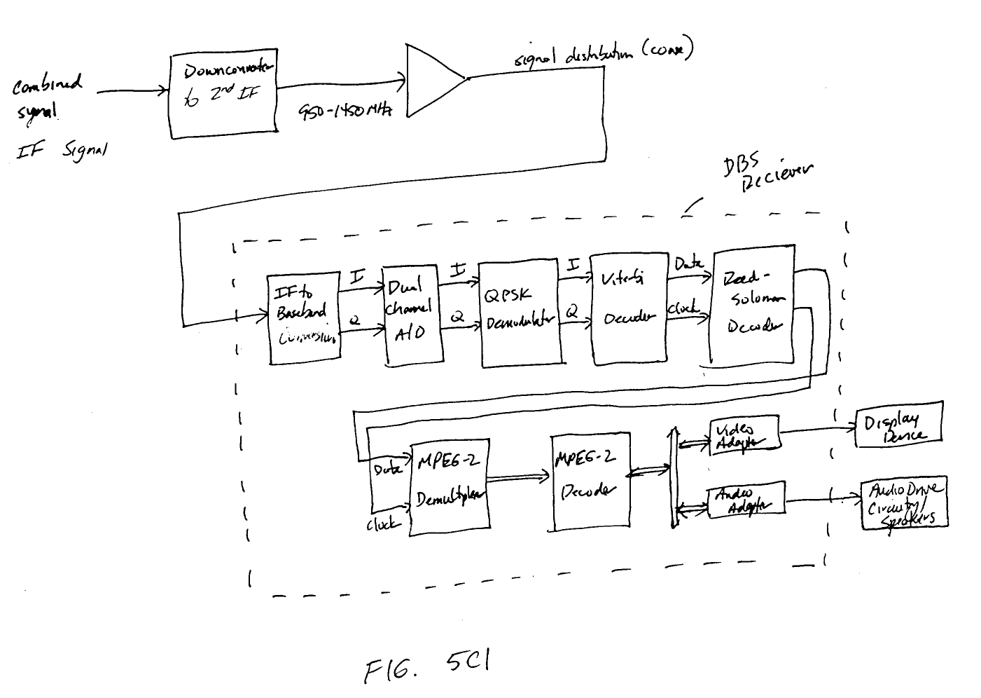

FIG. 5A1 illustrates the architecture of an exemplary receiving phased array communication system 500 in accordance with the present invention, including a number of antenna elements 501₁, . . . 501_{N-2}, 501_{N-1}, 501_{N} that receive a signal, which typically has a plurality of frequency-divided channels therein. The signal from each antenna element is supplied to a number of components (referred to below as a processing channel) that operate on the signal produced by the given antenna element as follows. In a given processing channel x (where x identifies any one of the N processing channels shown), the antenna signal is amplified (and possibly filtered) by amplifier 503ₓ. A portion of this signal (e.g., a select number of the incident frequency-divided channels), which is set by the frequency of the local oscillating signal supplied to the mixer 505ₓ, is downconverted into a lower frequency signal by downconverting mixer 505ₓ. The lower frequency signal produced by the downconverting mixer 505ₓ is filtered by a band-pass filter 507ₓ that removes unwanted harmonics produced by the downconverting mixer 505ₓ. The resultant signal produced by each of the N processing channels is then combined by a summing amplifier 509 to produce a combined signal that is output to signal analysis circuitry for subsequent processing (which typically involves demodulation and decoding that extracts information contained in the combined signal produced by the summing amplifier 509).

An antenna pattern for the combined signal is formed by delivering oscillating waveform signals with increasing phase delays to the downconverting mixers 505_{N} . . . 505₁ to compensate for phase difference in the received signal over the antenna elements of the receiving phased array communication system as described above with respect to FIG. 4. The oscillating waveform signals with different phase delays are derived from a local oscillator 511 that generates a local oscillating signal, and a delay line network having a plurality of fixed delay lines 513_{N} . . . 513₁ (preferably, implemented with microstrip traces) that are arranged in a serial manner to introduce increasing fixed phase delays in the local oscillating signal. The signal produced by each fixed delay line in the network is output via a corresponding tap in the delay line network to form oscillating waveform signals with increasing phase delays. The series of oscillating waveform signals with increasing phase delay are supplied to the corresponding downconverting mixers 505_{N} . . . 505₁ of FIG. 5A1 to compensate for phase delay in the signal received over the antenna elements 501_{N} . . . 501₁ of the system.

It should be noted that the center frequency of the combined signal produced by the summing amplifier 509 changes according to the beam positioning direction [symbol] and the corresponding frequency of the local oscillating signal supplied to the mixers 505ₓ in each processing channel. This change in center frequency of the combined signal can be compensated by a second stage frequency converting mixer 512 as shown in FIG. 5A2. Preferably, such compensation is obtained by controlling a second local oscillator 513 to vary the frequency of a second local oscillating signal (by the same amount as the local oscillating signal produced by the local oscillator 511) produced therefrom, and supplying this second local oscillating signal to the second stage frequency converting mixer 512 as shown.

FIG. 5B1 illustrates an exemplary transmitting phased array communication system 520 including a number of antenna elements 501_{N} . . . 501₁. A transmit signal, which is typically a modulated signal produced by a transmit signal source as shown, is provided by a splitter 521 to a number of processing channels that operate on the transmit signal supplied thereto. Each processing channel includes a number of components that operate on the transmit signal supplied thereto as follows. In a given processing channel x (where x identifies any one of the N processing channels shown), the transmit signal is upconverted to a higher frequency by upconverting mixer 523ₓ. The resultant signal subjected to filtering by a bandpass filter 525ₓ that removes unwanted harmonics produced by the upconverting mixer 523ₓ. The resultant signal produced by the bandpass filter 525ₓ is amplified by amplifier 527ₓ and is supplied to the corresponding antenna 501ₓ for transmission.

An antenna pattern for the transmit signal is formed by delivering oscillating waveform signals with increasing phase delays to the upconverting mixers 523_{N} . . . 523₁ to introduce phase difference in the transmit signal over the antenna elements of the transmitting phased array communication system (which is analogous to the phase difference in the received signal as described above with respect to FIG. 4). The oscillating waveform signals with different phase delays are derived from a local oscillator 531 that generates a local oscillating signal, and a delay line network having a plurality of fixed delay lines 533_{N} . . . 533₁ (preferably, implemented with microstrip traces) that are arranged in a serial manner to introduce increasing fixed phase delays in the local oscillating signal. The signal.produced by each fixed delay line in the network is output via a corresponding tap in the delay line network to form oscillating waveform signals with increasing phase delays. The series of oscillating waveform signals with increasing phase delay are supplied to the corresponding upconverting mixers 525_{N} . . . 525₁ to introduce phase delay in the signals transmitted over the antenna elements 501_{N} . . . 501₁ of the system.

It should be noted that the center frequency of the signals produced by the upconverting mixers 523ₓ in each processing channel change according to the beam positioning direction [symbol] and the corresponding frequency of the local oscillating signal supplied to the mixers 523ₓ in each processing channel. This change in center frequency can be compensated by a second stage frequency converting mixer 532 that operates on the transmit signal as shown in FIG. 5B2. Preferably, such compensation is obtained by controlling a second local oscillator 533 to vary the frequency of a second local oscillating signal (by the same amount as the local oscillating signal produced by the local oscillator 531) produced therefrom, and supplying this second local oscillating signal to the second stage frequency converting mixer 532 as shown.

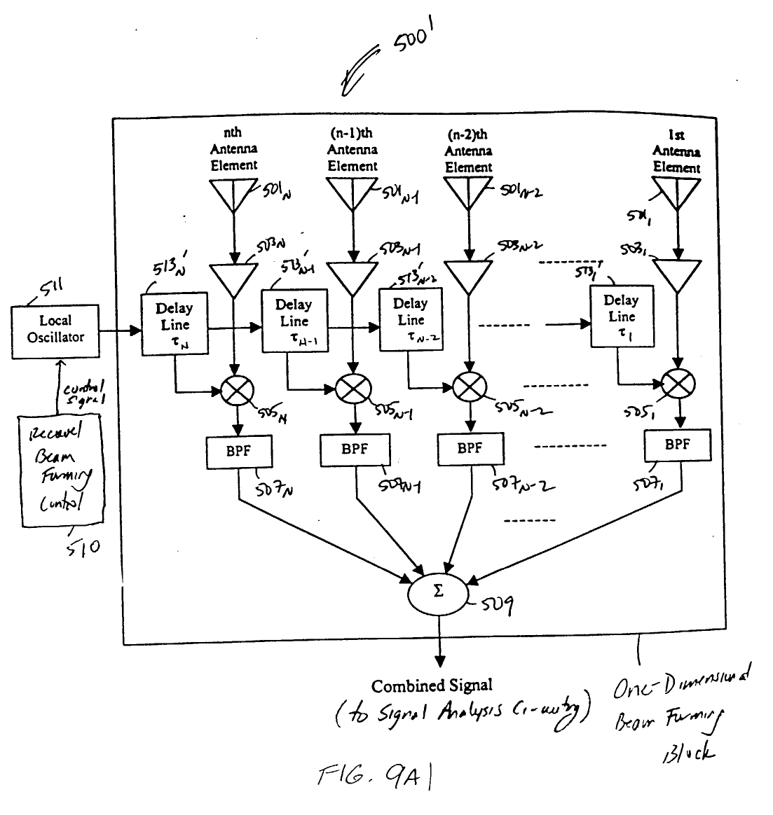

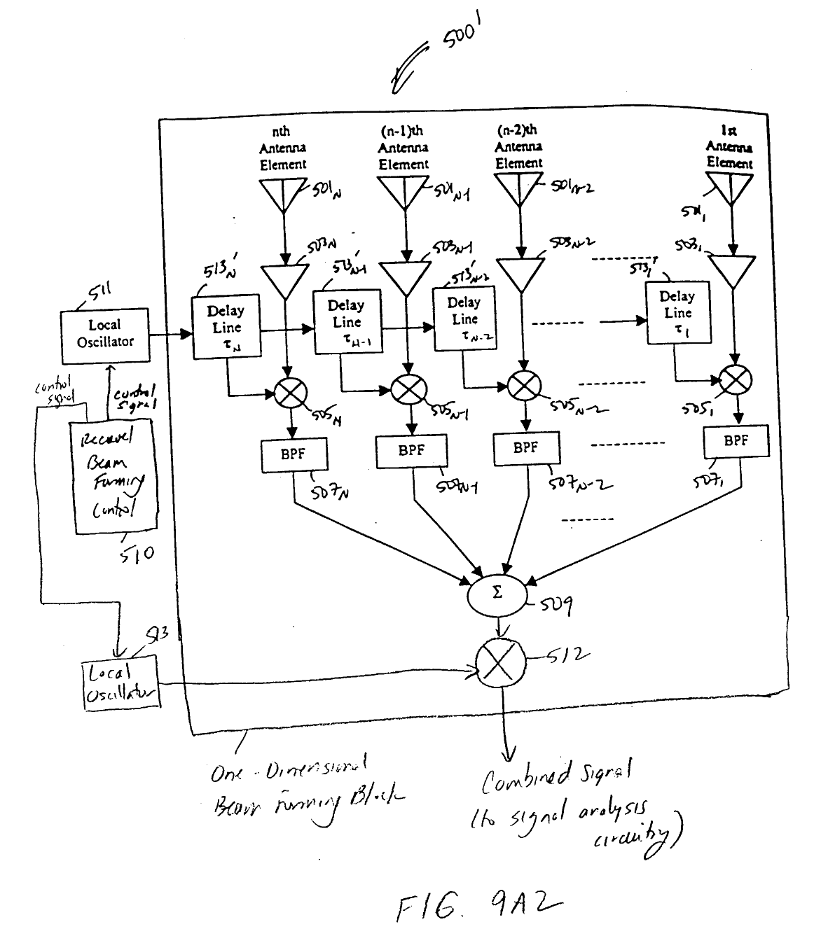

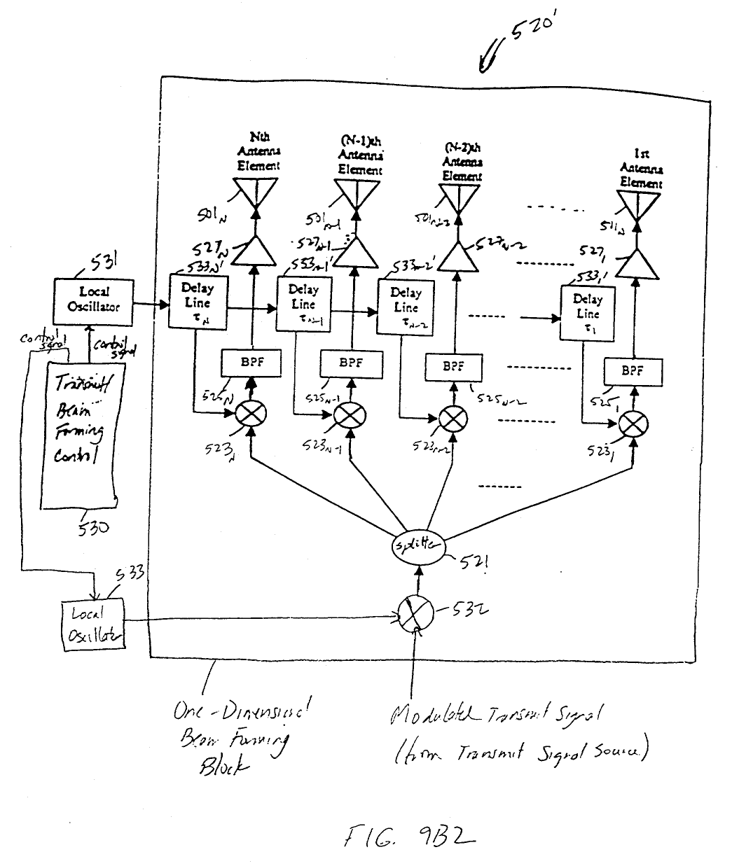

In the phased array communication systems of FIGS. 5A1, 5A2, 5B1, and 5B2, the antenna elements are equally spaced apart. In this configuration, each delay line provides a constant delay time τ. In alternate,embodiments described below with respect to FIGS. 8, 9A1, 9A2, 9B1 and 9B2, the spacing between antenna elements varies. In this configuration, the delay lines provide a series of delay times τ_{N} τ₋₁ that correspond to the antenna spacing values d_{N} . . . d₁.

Assuming that the frequency of the local oscillating signal produced by the local oscillators 511/531 is f_{LO} and the time delay provided by each delay line is a constant delay time τ, the incremental phase shift of the resultant oscillating signal provided by each delay line is 2*τ*f_{LO}*τ. If the delay τand the frequency f_{LO} are specified such that:

2*τ*f_{LO}*τ=(2*τ*f_{c}*d*cos( [symbol] )/c,

the phase differences over the antenna elements correspond to the [symbol] direction. To point the system toward a different direction [symbol] , the frequency of the local oscillating signal can be adjusted to f_{LO}′ such that

2*τ*f_{LO}′*τ=(2*τ*f_{c}*d*cos( [symbol] )/c,

and solving for f_{LO}′ yields

f_{LO}=(f_{c}*d*cos( [symbol] ′)/(τ*c).

In this manner, the receive/beam forming control block 510 of FIGS. 5A1 and 5A2 and the transmit/beam forming control block 530 of FIGS. 5B1 and 5B2 supply a control signal to the corresponding local oscillator 511, 531, respectively, that varies the frequency of the local oscillating signal such that the pointing direction [symbol] of the system varies.

If the phased array communication system needs to steer the antenna between a minimum direction [symbol] ₘᵢₙ and maximum direction [symbol] ₘₐₓ, the frequency of the local oscillating signal minimally must be adjustable in range Δf specified by:

Δf=((f_{c}*d)/(τ*c))*(max[(cos ( [symbol] )]−min[(cos ( [symbol] )])

where the max and min functions are evaluated over the range of

[symbol]

ₘᵢₙ< [symbol] < [symbol] ₘₐₓ.

If, for example, [symbol] ₘᵢₙ and [symbol] ₘₐₓ differ by 180 degrees, the frequency of the local oscillating signal minimally must be adjustable in range f specified by:

Δf=((f_{c}*d)/(τ*c))*2.

Moreover, if the distance between each antenna element, for example, is one wavelength of the carrier frequency, then

Δf=2/τ.

Finally, if the delay lines are implements with microstrip traces with an effective dielectric constant of εₑ of length ζ, the signal delay is specified by:

τ=(ζ*sqrt(εₑ))/c.

This gives a minimal frequency range of the local oscillating signal for the example as follows:

Δf=(2*c)/(4*sqrt(εₑ))

Thus, a longer signal delay τ results in lower frequency range shift that must be performed by the local oscillator.

In illustrative embodiments of the present invention, the receiving phased array communication system described above with respect to FIGS. 5A1 or 5A2 can be configured to receive a frequency-division-multiplexed signal typically used in satellite communication. As an example, the Direct Broadcast Satellite (DBS) signal lies in a frequency band from 12.25 to 12.75 GHz. The signal is transmitted via two antenna polarizations (left-handed circular and right-handed circular polarization). Each antenna polarization carries sixteen transponder channels (each having a bandwidth of approximately 30 MHz) over the entire frequency band (12.25 GHz to 12.75 GHz). The DBS receiver (sometimes referred to as a “set top box” herein) receives only one transponder channel within the entire band at a time. In such a configuration, each amplifier 503ₓ and downconverting mixer 505ₓ downconvert the received signal from the corresponding antenna element 501ₓ to an intermediate frequency (containing multiple 30 MHz transponder channels). The bandpass filter 507ₓ removes unwanted harmonics produced by the downconverting mixer 505ₓ. The output of the bandpass filters 507_{N} . . . 507₁ are supplied to the summing amplifier 509, where they are combined to form the combined signal. Alternatively, the output of the summing amplifier 509 can be compensated by a second stage frequency converting mixer 512 to form the combined signal as shown in FIG. 5A2. The combined signal is then output to signal analysis circuitry.

The combined signal contains multiple 30 MHz transponder channels. Each transponder channel includes multiple MPEG data streams. Generally, the signal analysis circuitry operates to downconvert the combined signal to a second IF (intermediate frequency), which may be at 950 MHz to 1.450 GHz. The signal analysis circuitry then further demodulates the combined signal to a baseband signal representing one 30 MHz transponder channel. The baseband signal is converted into digital form by analog-to-digital conversion circuitry and supplied to MPEG demodulating and decoding circuitry (that perform QPSK demodulation, forward error correction including Viterbi decoding and Reed-Soloman decoding, MPEG-2 transport demultiplexing, and MPEG-2 decoding). The output of MPEG-2 decoding is a digital bit stream that characterizes the original video and sound for the selected channel. This digital bit stream is supplied to a video adapter that produces a video signal (such as NTSC signal) that is provided to a display device. For example, the video adapter may produce a NTSC signal that is modulated onto channels 3 or 4 for tuning and display on a standard television. In addition, the audio portion of the digital bit stream may be supplied to an audio adapter that generates an analog audio signal for supply to audio drive circuitry and one or more speakers that recreate the sound for the selected channel.

FIGS. 5C1 through 5C3 illustrate three different exemplary embodiments for carrying out signal analysis on the combined signal (e.g., an intermediate frequency signal containing multiple 30 MHz transponder channel that includes multiple MPEG-2 data streams therein) to produce the original video and sound for a selected channel.

In the embodiment of FIG. 5C1, the combined signal is downconverted to a second intermediate frequency (for example, the second IF may be a 950-1450 MHz signal as shown). The second IF signal is amplified and distributed over a signal distribution network (typically implemented with coaxial cable) to a DBS receiver. The DBS Receiver includes IF-to-Baseband Conversion Circuitry that demodulates the second IF signal to a baseband signal (I and Q components) representing one 30 MHz transponder channel. The baseband signal includes multiple MPEG data streams therein. A dual-channel analog-to-digital converter converts the baseband signal (I,Q components) into digital form. The MPEG demodulating and decoding circuitry (including QPSK demodulation circuitry, Viterbi Decoder and Reed-Soloman decoder, MPEG-2 Demultiplexer and MPEG-2 Decoder) produce a digital bit stream that characterizes the original video and sound for a selected channel. This digital bit stream is supplied to a video adapter that produces a video signal (such as NTSC signal) that characterizes the original video in the selected channel for display on a display device. For example, the video adapter may produce a NTSC signal that is modulated onto channels 3 or 4 for tuning and display on a standard television. In addition, the audio portion of the digital bit stream may be supplied to an audio adapter that generates an analog audio signal that recreates the sound for the selected channel for supply to audio drive circuitry and one or more speakers.

In the embodiment of FIG. 5C2, the combined signal is amplified and transmitted over an RF link to a receiver that receives the intermediate frequency signal and downconverts the received signal to a second intermediate frequency (for example, the IF may be a 950-1450 MHz signal as shown). The second IF signal may be amplified and distributed over a signal distribution network (not shown) and supplied to a DBS receiver as described above with respect to FIG. 5C1. The DBS Receiver produces a video signal (such as NTSC signal) that characterizes the original video in the selected channel for display on a display device and preferably generates an analog audio signal that recreates the sound for the selected channel for supply to audio drive circuitry and one or more speakers. This configuration is preferable for mobile DBS applications wherein the receiving phased array antenna system and transmitter (that transmits the combined signal) is disposed on one or more exterior surfaces of a mobile vehicle and the receiver and DBS receiver are disposed on the interior of the vehicle (as disclosed in co-owned U.S. Ser. No. 10/016,215), thereby avoiding drilling through the vehicle to operably couple the receiving phased array antenna system to the DBS Receiver.

In the embodiment of FIG. 5C3, the combined signal is downconverted to a second intermediate frequency (for example, the IF may be a 950-1450 MHz signal as shown). IF-to-Baseband Conversion Circuitry demodulates the second IF signal to a baseband signal (I and Q components) representing one 30 MHz transponder channel. The baseband signal includes multiple MPEG data streams therein. A dual-channel analog-to digital converter converts the baseband signal (I,Q components) into digital form. The MPEG demodulating circuitry (including QPSK demodulation circuitry, Viterbi Decoder and Reed-Soloman decoder) produce an MPEG digital data stream. This data stream is encapsulated in IP packets processed by a router/wireless transceiver for transmission/reception by one or more Wireless Receivers over a wireless link therebetween. The Wireless DBS Receiver includes a wireless transceiver that communicates over the wireless link to receive the packetized data stream, and a data extraction block that recovers the MPEG data stream from the packetized data stream. The MPEG-2 Demultiplexer and MPEG-2 Decoder produce a digital bit stream that characterizes the original video and sound for a selected channel. This digital bit stream is supplied to a video adapter which produces a video signal (such as NTSC signal) that characterizes the original video in the selected channel for display on a display device. For example, the video adapter may produce a NTSC signal that is modulated onto channels 3 or 4 for tuning and display on a standard television. In addition, the audio portion of the digital bit stream may be supplied to an audio adapter that generates an analog audio signal that recreates the sound for the selected channel for supply to audio drive circuitry and one or more speakers. The wireless link between wireless transceivers preferably conforms to one or more of the following wireless communication protocols: IEEE 802.11A wireless communication protocol, IEEE 802.11B wireless communication protocol, and the Bluetooth wireless communication protocol. This configuration may be used in mobile DBS applications wherein the receiving phased array antenna system and router/wireless transceiver is disposed on one or more exterior surfaces of a mobile vehicle and the Wireless DBS Receiver are disposed on the interior of the vehicle (as disclosed in co-owned U.S. Ser. No. 10/016,215), thereby avoiding drilling through the vehicle to operably couple the receiving phased array antenna system to the Wireless Receiver. This configuration may be preferable if the phased array communication system is used for bidirectional data communications. It can also be used in applications where a network of wireless receivers need to be coupled to the same receiving phased array antenna system. In addition, it can also be used as a backhaul connection of a local area network to a wide area network.

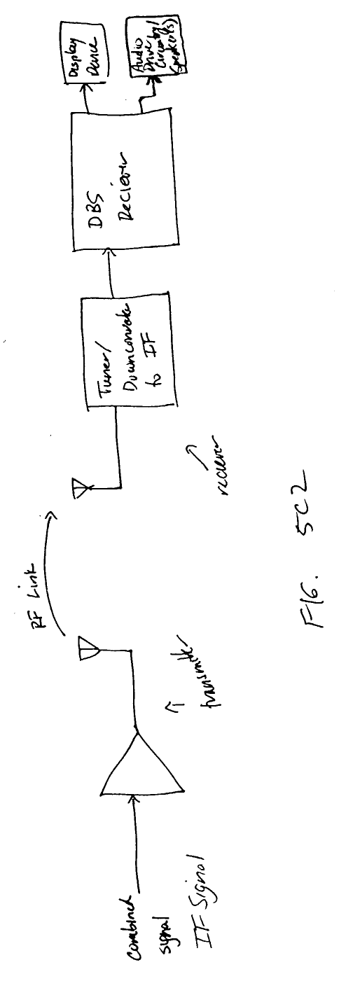

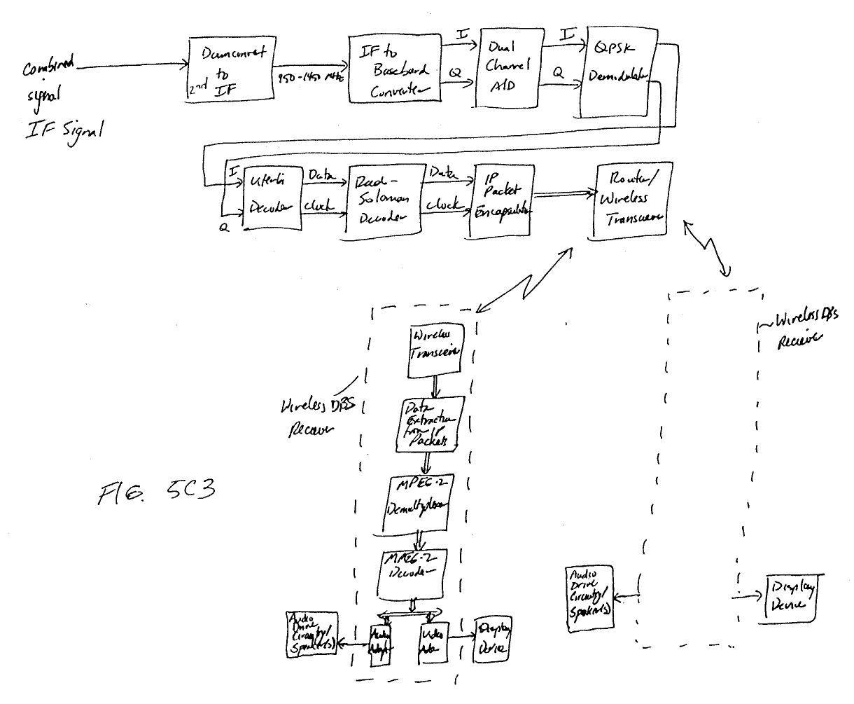

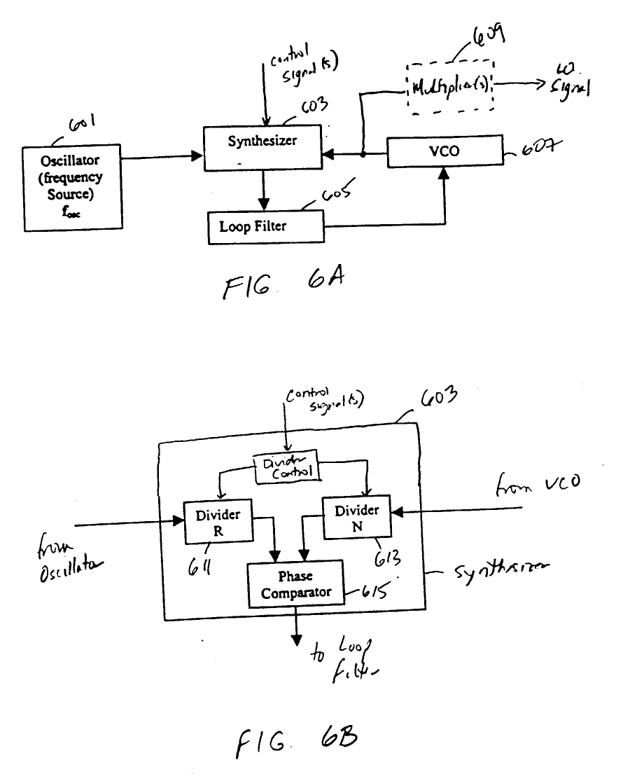

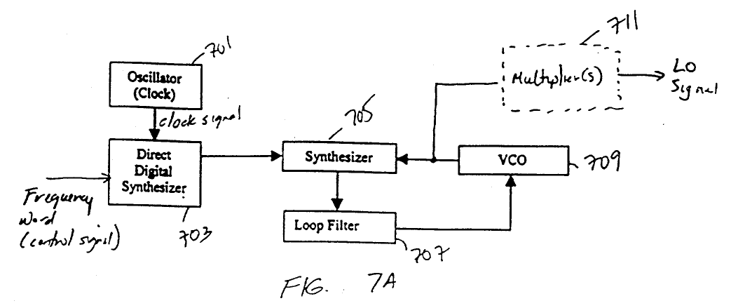

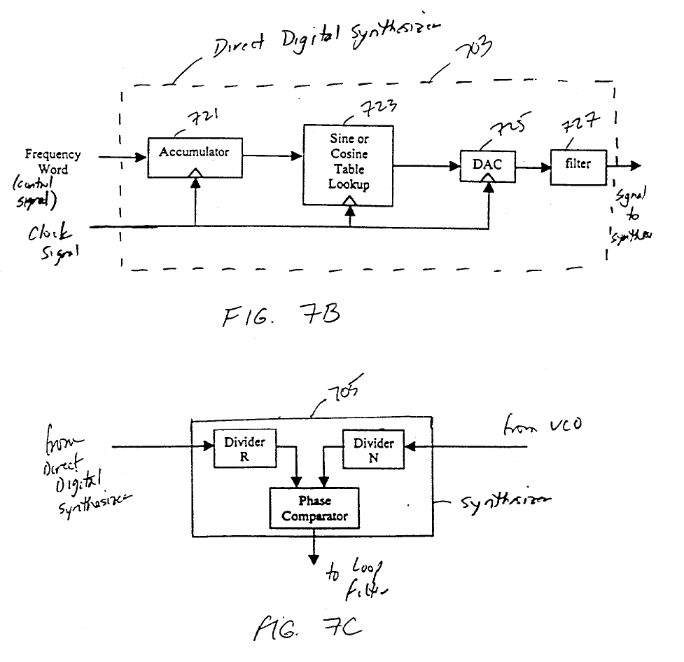

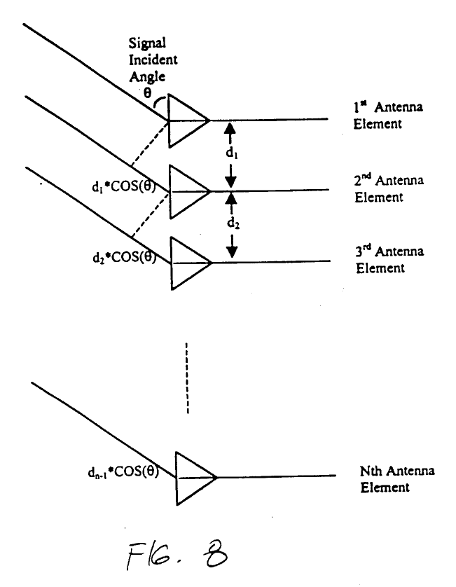

The local oscillator of the receiving and transmitting phase array communication systems described herein preferably utilize a phased-lock loop architecture. FIGS. 6A-6B and 7A-7C illustrate two exemplary local oscillators that utilize a phased-lock loop architecture.

The local oscillator of FIG. 6A includes an oscillator 601, synthesizer 603, loop filter 605, and voltage controlled oscillator 607. As shown in FIG. 6B, the synthesizer 603 includes a first divider 611 that divides down the frequency of the oscillator 601 by a factor R and a second divider 613 that divides down the frequency of the voltage controlled oscillator 607 by a factor N. A phase comparator 615 generates a first control signal (supplied to the loop filter 605) characteristic of the phase difference between output of the two dividers 611,613. The loop filter 605 produces a second control signal that is based upon the first control signal and that is supplied to the voltage controlled oscillator 607 to vary frequency of the signal produced by the voltage controlled oscillator 607 such that the phase difference is minimized.

The local oscillating signal output by the local oscillator is derived from the phase-locked oscillating signal produced by the voltage controlled oscillator 607. As shown, one or more multipliers may be used to multiply the frequency of the phase-locked oscillating signal to produce the local oscillating signal. This allows the other components to operate at a lower frequency, yet provide a high frequency local oscillating signal.

The frequency of the local oscillating signal is controllably selected by setting either one (or both) of the factors N and R for the dividers 611,613, which is preferably accomplished via control signals supplied to divider control logic that cooperates with the dividers 611,613 to effect such settings. There are many commercially-available synthesizers that can be readily used to implement the architecture of FIGS. 6A and 6B. An example of such a commercially-available synthesizer is the LMX2306 integrated circuit available from National Semiconductor.

The drawback of the local oscillator of FIG. 6A is that every time the voltage controlled oscillator 607 changes frequency (in response to a change in divider factor(s)), the synthesizer 603 will temporarily unlock for a short duration before it recovers to the phase-locked state. This unlocking is caused by the operation of loading the divider factor and the momentarily undefined state of the divider operation. The temporary unlocking of the voltage controlled oscillator 607 will effect the phase or frequency tracking of the output signal for the upconverting/downconverting mixer coupled to the local oscillator.

The local oscillator of FIG. 7A includes a reference oscillator 701, a direct digital synthesizer 703, synthesizer 705, loop filter 707, and voltage controlled oscillator 709. The reference oscillator 701 and direct digital synthesizer 703 generate a reference frequency signal for the synthesizer loop. The direct digital synthesizer is a digitally controlled device which employs a phase accumulator 721, phase-to-amplitude lookup table 723, digital-to-analog converter 725, and filter 727 as shown in FIG. 7B. The phase accumulator 721 increments in fixed step (set by the input frequency word) at each clock cycle. The increment in the accumulator 721 corresponds to phase increment. The phase step is determined by the resolution (number of bits) of the accumulator 721. For example, if the accumulator 721 contains N bits, the phase step is 360/2^{N} degree. The frequency of the reference frequency signal produced by the direct digital synthesizer 703 can be determined by: clock frequency/2^{N}*frequency word. The look-up table 723 converts the phase to the sine and cosine amplitude, and the converter 725 converts the digital sine and cosine values to an analog signal. The filter 727 removes the unwanted digital harmonics generated by the converter 725. There are many commercially-available direct digital synthesizers that can be readily used to implement the architecture of FIGS. 7A-7C. An example of such a commercially-available direct digital synthesizer is the AD9833 available from Analog Devices.

Turning to FIG. 7C, a synthesizer 705, loop filter 707 and voltage controlled oscillator 709 produce a local oscillating signal locked to the reference frequency signal produced by the direct digital synthesizer 703. Such operations are similar to the operation of these components described above with respect to FIGS. 6A and 6B.

The local oscillating signal output by the local oscillator is derived from the phase-locked oscillating signal produced by the voltage controlled oscillator 709. As shown, one or more multipliers may be used to multiply the frequency of the phase-locked oscillating signal to produce the local oscillating signal. This allows the other components to operate at a lower frequency, yet provide a high frequency local oscillating signal.

The frequency of the local oscillating signal is controllably selected by changing the frequency word provided to the direct digital synthesizer.

Note that direct digital synthesizer maintains phase continuity during frequency change. Thus, if the loop bandwidth of the phased-lock loop is properly designed and the changes in frequency are small, the synthesizer 705 can maintain phase lock during frequency changes. Such small steps can be accomplished by updating the frequency word supplied to the direct digital synthesizer in small steps at a higher rate.

In the phased array communication systems of FIGS. 5A1, 5A2, 5B1, and 5B2, the antenna elements are equally spaced apart. In this configuration, each delay line provides a constant delay time τ. In alternate configurations, the spacing between antenna elements may vary as shown in FIG. 8. In this configuration, the signal propagation delay between adjacent antenna elements is given by the expression: dᵢ*cos ( [symbol] ) where dᵢ is the distance between the adjacent antenna elements. If the incident signal is modulated at carrier frequency f_{c}, the signal propagation delay between adjacent antenna elements of dᵢ*cos( [symbol] ) corresponds to a phase difference given by the expression: 2*τ*f_{c}*d₁*cos( [symbol] )/c, where c is the propagation speed of the incident signal. In such a configuration, the delay line networks for the receiving phased array system and transmitting phased array systems are modified (as seen at 513′_{N} . . . 513′₁ and 533′_{N} . . . 533₁ of FIGS. 9A1, 9A2, 9B1 and 9B2 such that the delay lines provide a series of delay times τ_{N} . . . τ₁ that correspond to the antenna spacing values d_{N} . . . d₁. The operation of such systems is analogous to that described above with respect to FIGS. 5A1, 5A2, 5B1 and 5B2, respectively.

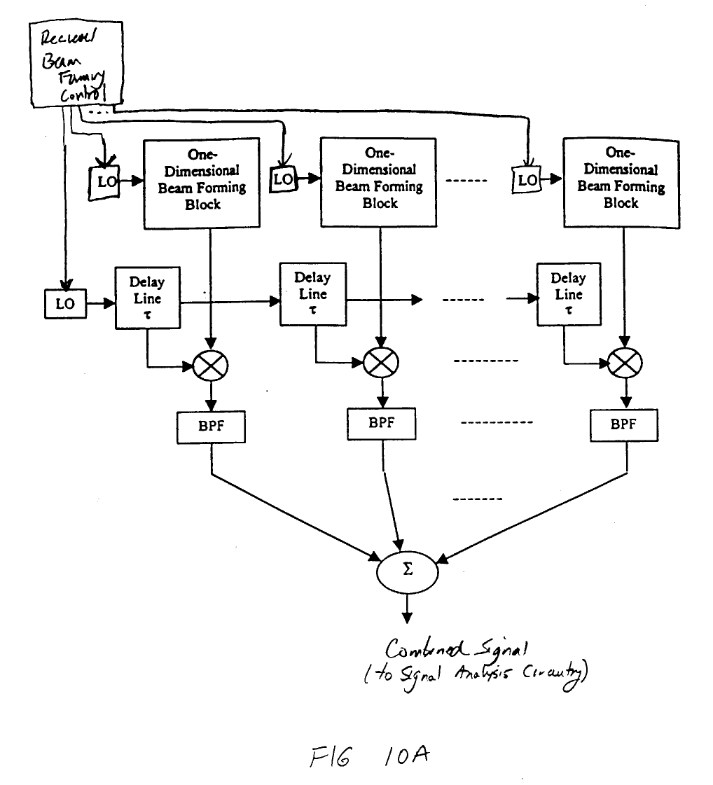

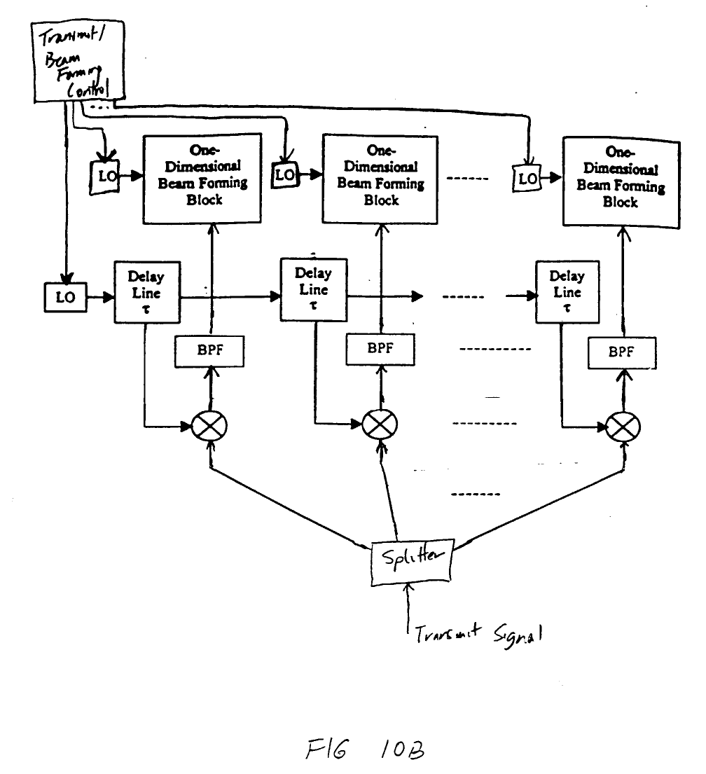

FIGS. 10A and 10B illustrate a receiving and transmitting phased array system for a two dimensional beam in accordance with the present invention. Note that the first dimensional beam forming blocks in FIGS. 10A and 10B are described above with respect to FIGS. 5A1/5A2 and 5B1/5B2, respectively. Note that the local oscillator of all first dimensional beam forming blocks in FIGS. 10A and 10B are phased-locked to a common frequency source. In the receiving phased array system of FIG. 10A, the output signal formed by each one-dimensional beam forming block is processed through an additional downconverting mixer and bandpass filter. The resultant signals are combined by a summing amplifier to form a two-dimensional beam, which is output to signal analysis circuitry for processing as described above. Similar to the operation of the one-dimensional beam forming block in FIGS. 5A1 and 5A2, oscillating waveform signals with different phase delays are supplied to the downconverting mixers (that produce the two-dimensional beam) to compensate for phase difference in the received signal over the antenna elements of the receiving phased array system. The oscillating waveform signals are preferably derived from a local oscillator and a delay line network having a plurality of fixed delay lines as shown and described above in detail.

In the transmitting phased array system of FIG. 10B, the transmit signal is split into multiple copies each supplied to a bandpass filter and upconverting mixer. The output of each upconverting mixer is supplied to a one dimensional beam forming block as described above with respect to FIGS. 5B1 and 5B2 to produce a two-dimensional beam for transmission by the antenna elements. Similar to the operation of the one-dimensional beam forming block in FIGS. 5B1 and 5B2, oscillating waveform signals with different phase delays are supplied to the upconverting mixers (that produce the two-dimensional beam) to introduce phase differences in the transmit signal over the antenna elements of the transmitting phased array system. The oscillating waveform signals are preferably derived from a local oscillator and a delay line network having a plurality of fixed delay lines as shown and described above in detail.

It should be noted that the delays introduced by the delay lines in the delay networks shown in FIGS. 10A and 10B are proportional to the spacing between the antenna elements between adjacent one-dimensional arrays that are to be combined. It should also be noted that the element spacing of each first dimensional array need not be the same as long as the delays introduced by the delay lines are proportional to the corresponding element spacings. In addition, the frequency of the local oscillating signal that forms the second dimension of the beam preferably is set to a different frequency than the frequency of the local oscillator of the one dimensional beam forming block.

It should also be noted that additional frequency converting mixing stages may be employed at the output of the summing amplifier of FIG. 10A (or the input to the signal splitter of FIG. 10B) to compensate for center frequency changes as described above with respect to FIGS. 5A2 and 5B2.

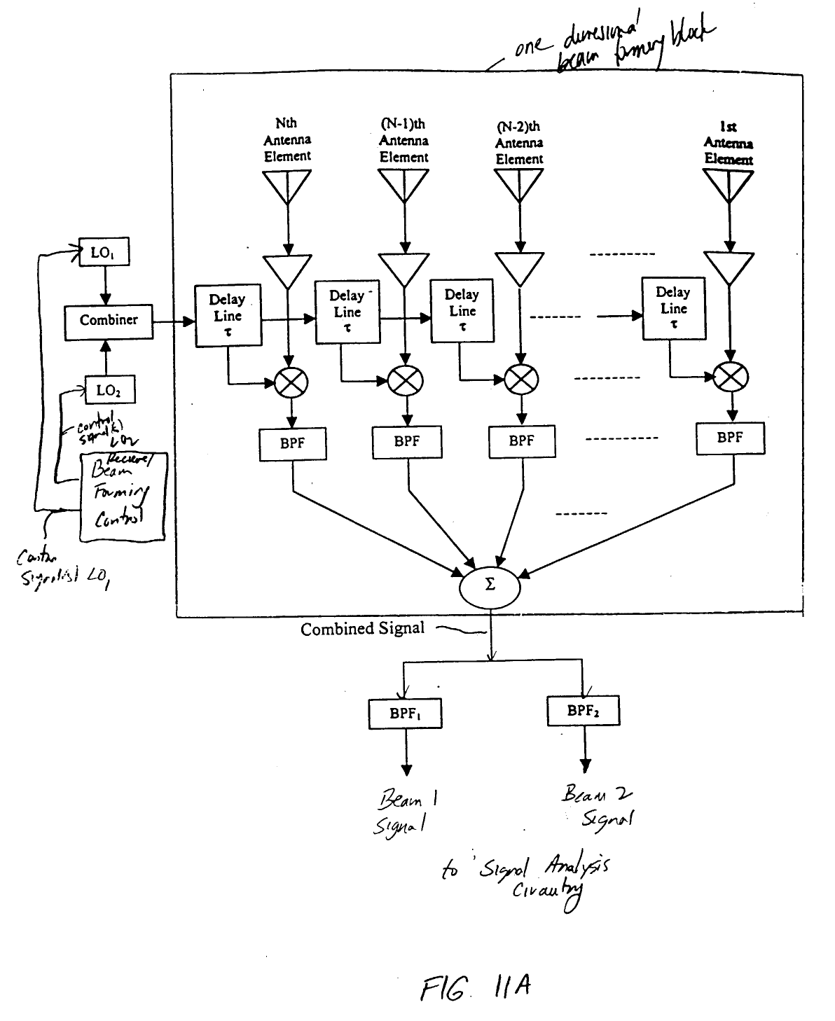

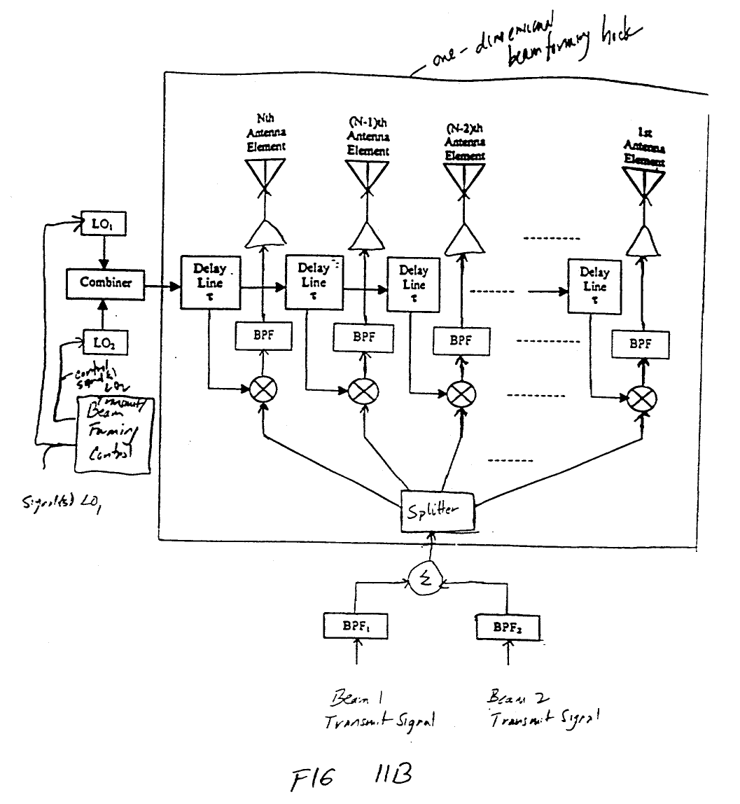

FIGS. 11A and 11B illustrate a receiving and transmitting phased array system that produce multiple beams in accordance with the present invention. The one dimensional beam forming blocks in FIGS. 11A and 11B are described above with respect to FIGS. 5A1/5A2 and 5B1/5B2, respectively. In the receiving phased array system of FIG. 11A, multiple local oscillators (two shown) generate multiple local oscillating signals that are combined (added) by a combiner and supplied to the downconverting mixers of the one dimensional beam forming block via the delay line network. The frequency ranges of the multiple local oscillating signals should not overlap and should separate by an amount that can be isolated by the corresponding bandpass filter stages that filter the combined signal to produce the multiple beams.

In the transmitting phased array system of FIG. 11B, multiple local oscillators (two shown) generate multiple local oscillating signals that are combined (added) by a combiner and supplied to the upconverting mixers of the one dimensional beam forming block via the delay line network. Here too, the frequency ranges of the multiple local oscillating signals should not overlap and should separate by an amount that can be isolated by the corresponding bandpass filter stages that filter the multiple transmit signals that are added and then split into copies for upconversion in the one dimensional beam forming block.

The frequency of the local oscillators can be independently controlled to provide independent steering of the multiple beams in a selected direction.

It should also be noted that additional frequency converting mixing stages may be employed at the output of the summing amplifier of FIG. 11A (or the input to the signal splitter of FIG. 11B) to compensate for center frequency changes as described above with respect to FIGS. 5A2 and 5B2.

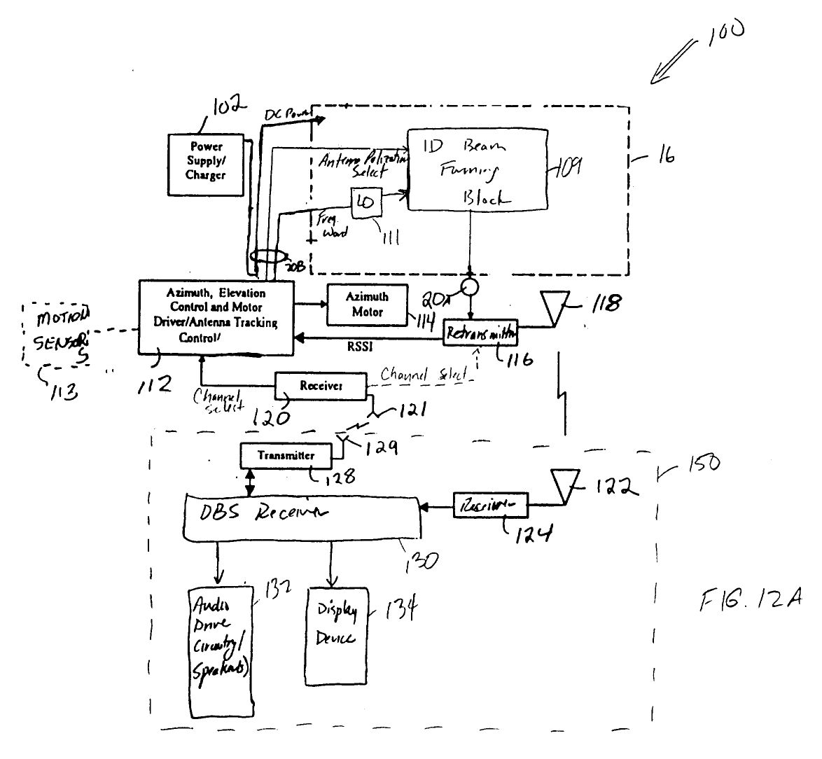

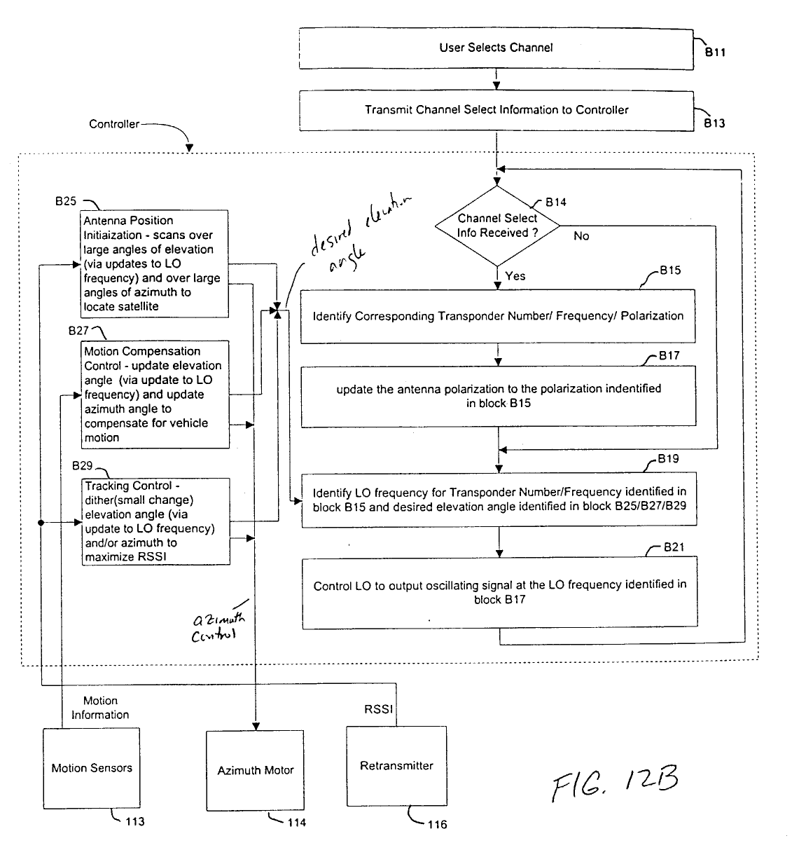

FIG. 12A illustrates, in schematic block diagram form, an exemplary embodiment of a phased array receiving communication in accordance with the present invention, which is suitable for use in receiving satellite signals (such as DBS signals) in a vehicle. The overall system 100 includes components which are mounted above the rotatable platform 16 as well as components mounted on a base plate (not shown) below the platform 16. The components mounted above the platform 16 are shown in FIG. 12A as surrounded by a phantom line box. These components include a one-dimensional beam forming block 109 as shown in FIGS. 5A1/5A2 and/or 9A1/9A2 and described herein in great detail. Preferably, the polarization (e.g., LHCP or RHCP) of incident electromagnetic radiation received by each antenna element of the one-dimensional beam forming block 109 may be selected in response to a control signal (antenna polarization select signal) as shown in FIG. 12A. As described above in great detail, varying the frequency of the oscillating signal produced by the local oscillator (LO) 111 provides a beam steering function in the one dimensional beam forming block 109. In this configuration, such beam steering is used to vary elevation angle of the system 100 as described below in more detail.

The output of the one dimensional beam forming block 109 is passed via the rotary joint 20A to a retransmission tuner 116 located on the base plate below the rotatable platform 16. The connection of DC power and various control signals is effected via slip ring 20B. Preferably, the slip ring is realized as a number of concentric circular traces on a circuit board surrounding the rotary joint 20A and mounted to the rotatable platform 16. A corresponding number of brushes are mounted on another circuit board surrounding the rotary joint 20A and mounted on the base plate. The brushes are preferably made from beryllium copper pins with brush blocks on their ends. The brush blocks are made from a phosphor bronze alloy with silver plating. The circuit boards are aligned so that each brush block contacts one of the circular traces.

The remainder of the components of the system 100 which are located on the exterior of the vehicle include a power supply/charger 102 (e.g., rechargable battery) and possibly other power-related components (such as a solar cell, wind powered generator, AC adaptor, etc), an azimuth motor 114, the retransmission tuner 116 having a retransmission antenna 118, a receiver 120 having an antenna 121, and a controller 112 (e.g., microprocessor-based control system) which may be coupled to motion sensors 113. The power supply 102 (and possibly other power-related components) provides DC power to all of the components of the system 100. The controller 112 controls the azimuth motor 114 (rotating platform) and elevation angle (via control over the frequency of the local oscillating signal produced by the local oscillator 111 through the slip ring 20B) to point the antenna elements in the desired direction. In addition, the controller 112 controls polarization of the antenna elements (via control signal supplied thereto through the slip ring 20B) in response to user channel selection. The controller 112 also receives RSSI (received signal strength indicator) information from the retransmitter 116 (for satellite tracking) and channel select information from the receiver 120 (for channel selection). The retransmission tuner 116 retransmits the combined signal produced by the one dimensional beam forming block 109 (preferably as a second IF signal over a wireless link as described above with respect to FIG. 5C2) to a vehicle inboard unit 150 (described below), and the receiver 120 receives signals via an antenna 121 from the vehicle inboard unit 150 over a wireless link therebetween.

The vehicle inboard unit 150 includes a receiver antenna 122 coupled to a receiver 124, which cooperate to receive the combined signal retranmitted by the retransmission tuner 116 and antenna 118 over the wireless link therebetween and forward this signal to DBS Receiver 130. As described above, the DBS receiver 130 generally includes IF-to-Baseband Conversion Circuitry that demodulates the signal to a baseband signal that includes multiple MPEG data streams therein. A dual-channel analog-to-digital converter converts the baseband signal produce a digital bit stream that characterizes the original video and sound for a selected channel. This digital bit stream is supplied to a video adapter that produces a video signal (such as NTSC signal) that characterizes the original video in the selected channel for display on a display device 134. For example, the video adapter may produce a NTSC signal that is modulated onto channels 3 or 4 for tuning and display on a standard television. In addition, the audio portion of the digital bit stream may be supplied to an audio adapter that generates an analog audio signal that recreates the sound for the selected channel for supply to audio drive circuitry and one or more speakers 132.

The DBS Receiver 130 also includes a user interface (e.g., infra-red remote control and supporting circuitry, user-activated buttons, and/or touch keypad) through which user commands are input to enable channel selection. This channel select information is passed by the DBS Receiver 130 to the transmitter 128, which cooperates with antenna 129 to transmit such information to the antenna 121 and receiver 120 over the wireless communication link therebetween. The receiver 120 passes this channel select information to the controller 112 to update the polarization and tuning frequency of the antenna elements of the one dimensional beam forming block 109.

FIG. 12B illustrates an exemplary control scheme carried out by the controller 112 of FIG. 12A for controlling elevation and azimuth of the system 100 in addition to controlling polarization and tuning frequency of the antenna elements of the one dimensional beam forming block 109 in response to user channel selection.

The control operations preferably include an antennae position initialization routine (block 25) that controls the azimuth angle (e.g., azimuth pointing direction) with control over azimuth motor 114 and elevation angle (e.g., elevation pointing direction) with control over the frequency of the LO 111 to scan through possible satellite positions to search for a satellite signal. Typically, this involves scanning the 360 degree azimuth angle at a given elevation angle, incrementally changing the elevation angle, and repeat the azimuth scan. Preferably, an electronic compass is utilized and the location of the satellite is known. Thus, it will not be necessary to scan the entire hemisphere, but only a relatively small region based on the accuracy of the compass and the satellite position. During the antenna position initialization routine (block 25), the tracking control routine of block B29 (described below in more detail) is disabled and the controller 112 monitors the RSSI signal output by the retransmitter 116. If the power controller 112 detects that the signal strength exceeds a certain threshold, the scanning is stopped immediately and the tracking control routine of block B29 is activated. In addition, the information provided by the DBS receiver 130 may be monitored to determine whether the antennae are pointed at the desired satellite and if the signal is properly decoded. If that is the case, the signal lock is achieved. Otherwise, the tracking control operation of block B29 is disabled and the scanning is resumed. When achieving signal lock, the controller 112 continues to record satellite position (elevation and azimuth) in space. In the case that the signal is blocked by trees, buildings, or other obstacles, the RSSI signal (and/or possibly status information provided by the DBS Receiver) will provide an indication of loss of signal. Upon detection of loss of signal, the controller 112 will control the azimuth motor 114 and update the frequency of the LO 111 such that the antenna is moved back to the azimuth and elevation at the last satellite position recorded, when the satellite signal was properly locked and/or decoded. In addition, upon loss of signal, the controller 112 will temporarily disable the tracking control operations of block B29. If the controller 112 again detects signal lock and/or proper decoding, the controller 112 will enable the tracking control operations of block B29. In the event that the controller 112 detects lack of signal strength (not exceeding the threshold) and/or improper decoding status for a certain time-out period, the controller 112 will initiated a scanning operation to scan for location of the satellite. Preferably, this scanning operation (for signal re-acquisition) will scan in a limited region around the last satellite position recorded, when the satellite signal was properly decoded. If the scanning does not find the satellite signal, a full scan of 360 degrees of azimuth angle and all possible elevation angles will be conducted.

The system 100 preferably includes motion sensors 113 which sense vehicle motion and pass information regarding such motion to the controller 112. In such a configuration, the controller 112 includes a motion compensation control routine, which controls the azimuth and elevation angles of the antenna elements in a manner that compensates for vehicle motion (e.g., by moving the antenna pointing in the opposite direction of the vehicle motion). Preferably, the motion sensors 113 utilize accelerometers and yaw, roll, and pitch sensors to sense the yaw, pitch, roll rates, longitudinal and lateral acceleration of the vehicle. The estimated yaw, roll and pitch rates are integrated to yield the vehicle yaw, pitch, and roll angle. This is used in a coordination transformation to the earth-fixed coordinate system to determine the azimuth and elevation travel of the antennae. The antennae will be turned in the opposite directions by the same amount to counteract the vehicle motion. Any resulting pointing error is detected by a dithering process and corrected by the controller 112. Drift due to the inertia bias is the most significant source of pointing error and the tracking system compensates for it with dithering.

The motion compensation operations performed in block B27 is preferably accomplished through the following azimuth (Az) and elevation (El) update Equations (1) and (2).

Azₖ₊₁Azₖ−(φₓ cos(Azₖ)tan(Elₖ)+φ_{y} sin(Azₖ)tan(Elₖ)+φ_{z})ΔAt (1)

Elₖ₊₁Elₖ−(−φₓ sin(Azₖ)+φ_{y} cos(Azₖ))Δt (2)

where

Azₖ₊₁ is the new azimuth angle estimate relative to the vehicle body coordinate,

Azₖ is the most recent azimuth angle derived from the motor encoder output,

Elₖ₊₁ is the new elevation angle estimate relative to the vehicle body coordinate,

Elₖ is the most recent elevation angle derived from the motor encoder output,

φₓ, φ_{y}, φ_{z} are the newest roll, pitch, yaw sensor outputs minus the estimated bias, i.e., φₓ=φ_{x,raw}−roll bias , φ_{y}=φ_{y,raw}−roll bias, φ_{z}=φ_{z,raw}−roll bias, and φ_{x,raw}, φ_{y,raw}, φ_{y,raw} are the raw output of the roll, pitch, yaw sensors, and

Δt is the update time interval.

For accurate motion compensation, it is important that the bias for each sensor be properly estimated and compensated. A simple way to estimate the roll and pitch bias according to the invention is to monitor the output of longitudinal and lateral accelerometers as follows. The acceleration on the longitudinal accelerometer is y=g sin (roll angle) where g is the gravity acceleration. If y is not changing, there is no roll angle change and the readout of the roll angle sensor is the bias in roll sensor. The acceleration on the lateral accelerometer is x=g sin (pitch angle) where g is the gravity acceleration. If x is not changing, there is no pitch angle change and the readout of the pitch angle sensor is the bias in pitch sensor. When the receiving system has locked on and tracked the satellite signal, the estimate of the yaw sensor bias can be performed using either of the following pairs of Equations (3) and (4) or (5) and (6).

Yaw Sensor Bias=ΔAz+ΔEl tan(Az)tan(El) (3)

and

Pitch sensor bias=ΔEl sec(Az) (4)

assuming that roll bias has been calibrated to zero, or,

Yaw Sensor Bias=ΔAz+ΔEl cot(Az)tan(El) (5)

and

Pitch sensor bias=ΔEl csc(Az) (6)

assuming that pitch bias has been calibrated to zero,

where ΔAz and ΔEl are the antenna correction rates derived from monitoring the motor encoder output.

The bias calculation operations described above allow the biases in the roll, pitch, and yaw sensors to be continuously estimated and updated and removed from the measurements.

In addition to azimuth pointing direction and elevation pointing direction control as well as motion compensation, the controller 112 also includes a tracking control routine (block B29) that dithers (e.g., makes small adjustments) to the antenna pointing direction (in azimuth and elevation) such that the system 100 is pointed toward the direction of maximum signal strength. Dithering of elevation pointing direction is achieved by updating the frequency of the local oscillating signal produced by the local oscillator 111. This is equivalent to moving the antenna beam (upward or downward) in elevation. Dithering in the azimuth direction is achieved by controlling the azimuth motor 114 to make small adjustments in azimuth pointing direction. Alternatively, dithering in the azimuth pointing direction can be provided by combining signals for groups of antenna elements (e.g., two groups on opposite ends of the one dimensional array) and adding phase shift to the combined signal for specific groups prior to combining the signals for all the groups. By adjusting (incrementing or decrementing) this group phase shift, the azimuth direction of the antenna beam can be dithered.

It should be noted that such “electronic dithering” is advantageous due to lower power consumption as compared to that required for constantly mechanically dithering the antenna assembly. A second advantage is that the “electronic dithering” can be performed at a much faster speed than the “mechanical dithering”. Fast dithering operation means the antenna can track faster, which can eliminate the need for motion compensation and all the components (accelerometers and pitch, and yaw sensors) required by the motion compensation, resulting in a significantly lower cost implementation.

The controller 112 also performs control operations in blocks B14 to B21 that update the frequency of the local oscillator in response to the desired elevation angle identified in the antenna position initialization routine (B25), motion compensation control routine (B27) and tracking control routine (B29) and/or user channel selection (B11), and also updates the antenna polarization in response to such user channel selection, if need be. In block B11, the user selects a channel via interaction with the user interface of the DBS receiver 130. In block B13, channel select information (corresponding to the channel selected by the user in block B11) is communicated from the DBS Receiver 130 to the controller 112, preferably over the wireless link from the transmitter 129/antenna 119 to the antenna 121/receiver 120 shown in FIG. 12A. In block B14, the controller 112 determines whether or not channel select information has been received. If so, the operation continues to block B15; otherwise the operations skip to block B19. In block B15, the controller 112 identifies (typically via a look-up operation) the transponder number, frequency, and polarization that correspond to the channel select information received in block B14. In block B17, the polarization of the antenna elements are updated (via the antenna polarization select signal provided to the antenna elements of the beam forming block 109) to conform to the polarization identified in block B15. In block B19, the controller 112 calculates the frequency of the local oscillating signal produced by the local oscillator 111 in accordance with the desired elevation angle (identified in the antenna position initialization routine (B25), motion compensation control routine (B27) and tracking control routine (B29)) and/or in accordance with the transponder number and frequency identified in block B19. Finally, in block B21, the controller 112 updates the frequency of the local oscillating signal produced by the local oscillator 111 via the frequency word signal supplied to the local oscillator 111, and operations return to block B14 to repeat these control operations.

Advantageously, the improved phased array communication systems of the present invention are cost effective over the prior art architectures in that they avoid the use of costly and problematic analog-type variable gain amplifiers, analog-type variable phase shifters, and/or digital complex multipliers in favor of simple and inexpensive components that introduce phase delay into the oscillating waveforms supplied to the downconverting mixers and/or upconverting mixer in such systems. Moreover, the improved phased array communication systems of the present invention provide precise phase delay through the processing channels of the system for accurate beam steering, and are suitable for applications that require high bandwidth signals and/or a large number of antenna elements. In addition, the improved phased array communication systems of the present invention substantially reduce the need for calibration of the phase delay through the processing channels of the system, and thus is suitable for applications (such as consumer applications) that require limited maintenance by the end user.

Moreover, the improved phased array receiver of the present invention is suitable for use in satellite applications utilizing frequency-divided channels (such as Digital Broadcast Satellite (DBS) systems) and advantageously avoids the use of mechanical motors, linkages, and associated control mechanisms to adjust elevational angle of the satellite receiver. Instead, electronic elevational control is provided by accurate beam steering—precise phase delay control through multiple processing channels of the satellite receiver. In the preferred embodiment, elevation angle pointing direction of the satellite receiver is controlled by a local oscillator and fixed delay line network that introduce variable phase delay (which corresponds to the desired change in elevation angle pointing direction of the satellite receiver) to oscillating waveforms supplied to the downconverting mixers in the multiple processing channels of such systems.

There have been described and illustrated herein several embodiments of improved phased array antenna systems that are suitable for use in satellite applications utilizing frequency-divided channels such as Digital Broadcast Satellite (DBS) systems. While particular embodiments of the invention have been described, it is not intended that the invention be limited thereto, as it is intended that the invention be as broad in scope as the art will allow and that the specification be read likewise. Moreover, while particular configurations have been disclosed in reference to digital broadcast satellite DBS systems, it will be appreciated that other configurations could be used as well. It will therefore be appreciated by those skilled in the art that yet other modifications could be made to the provided invention without deviating from its spirit and scope as claimed.

What is claimed is:

1. A satellite receiver comprising:
a) an array of antenna elements each receiving electromagnetic radiation that includes a received signal within a first frequency band;
b) a plurality of tuners corresponding to said array of antenna elements, each tuner comprising an amplification stage, mixer and bandpass filter stage, said amplification stage and mixer operably coupled to a corresponding antenna element and operating on said received signal received at said corresponding antenna element to downconvert said received signal to a second frequency band lower than said first frequency band, and said bandpass filter stage operating on output of said mixer to remove unwanted signal components therein;
c) a summing amplifier for summing output of each bandpass filter stage in said plurality of tuners to produce a combined signal that is output for subsequent processing;
d) a local oscillator that generates a local oscillating signal;
e) delay means for introducing different phase delays to said local oscillating signal to generate a plurality of oscillating signal waveforms with different phase delays, and for supplying said plurality of oscillating signal waveforms to said mixers of said plurality of tuners; and
f) a controller that electronically adjusts an elevation angle pointing direction by varying frequency of said local oscillating signal.

2. A satellite receiver according to claim 1, wherein:
said delay means comprises a delay line network having a plurality of delay lines arranged in a serial manner to introduce increasing phase delays in said local oscillating signal.

3. A satellite receiver according to claim 1, wherein:
said controller includes an antenna position initialization routine that electronically adjusts elevation angle pointing direction by varying frequency of said local oscillating signal, wherein electronic adjustment of elevational angle pointing direction is scanned over a large range of elevational angle pointing directions to lock onto position of a transmitting satellite system.

4. A satellite receiver according to claim 2, wherein:
said controller includes a signal tracking routine that electronically adjusts said elevation angle pointing direction by varying frequency of said local oscillating signal in order maximize received signal strength of said received signal.

5. A satellite receiver according to claim 4, further comprising:
means for adjusting azimuth angle pointing direction; and
wherein said controller, during execution of said antenna position initialization routine, cooperates said means for adjusting azimuth angle pointing direction to vary said azimuth angle pointing direction over a large range of azimuth angle pointing directions to lock onto position of said transmitting satellite system.

6. A satellite receiver according to claim 5, wherein:
said controller, during execution of said signal tracking routine, cooperates said means for adjusting azimuth angle pointing direction to vary said azimuth angle pointing direction in order maximize received signal strength of said received signal.

7. A satellite receiver according to claim 6, wherein:
said controller varies frequency of said local oscillating signal in response to user channel selection information communicated thereto.

8. A satellite receiver according to claim 2, wherein:
said delay lines have lengths corresponding to distances between corresponding antenna elements.

9. A satellite receiver according to claim 8, wherein:
said delay lines have one of equal lengths and different lengths.

10. A satellite receiver according to claim 1, further comprising:
g) a second stage mixer that is operably coupled to an output of said summing amplifier and that operates on said combined signal to compensate for changes in center frequency of said combined signal; and
h) a second local oscillator that produces a local oscillating signal and that is supplied to said second stage mixer, wherein frequency of said local oscillating signal is varied to compensate for said changes in center frequency of said combined signal.

11. A satellite receiver according to claim 1, wherein:
said local oscillator comprises an oscillator, a synthesizer, a loop filter, and a voltage controlled oscillator,
wherein said synthesizer includes two dividers that divide down frequencies of said oscillator and said voltage controlled oscillator, respectively, and a phase comparator that generates a first control signal based upon phase difference between output of said two dividers, and
wherein said loop filter produces a second control signal that is based upon said first control signal and that is supplied to said voltage controlled oscillator to vary the frequency of the signal produced by the voltage controlled oscillator such that said phase difference is minimized.

12. A satellite receiver according to claim 11, wherein:
said local oscillating signal is derived from said signal produced by said voltage controlled oscillator.

13. A satellite receiver according to claim 12, wherein:
said local oscillating signal is produced by at least one multiplier that multiplies the frequency of the signal produced by said voltage controlled oscillator.

14. A satellite receiver according to claim 12, wherein:
the frequency of said local oscillating signal is controllably selected by setting a divider quotient for at least one of said two dividers of said synthesizer.

15. A satellite receiver according to claim 11, wherein:
said oscillator comprises a reference oscillator and a direct digital synthesizer that employs a phase accumulator, a phase-to-amplitude lookup table, a digital-to-analog converter, and filter.

16. A satellite receiver according to claim 15, wherein:
said local oscillating signal is derived from said signal produced by said oscillator.

17. A satellite receiver according to claim 16, wherein:
said local oscillating signal is produced by at least one multiplier that multiplies the frequency of the signal produced by said oscillator.

18. A satellite receiver according to claim 16, wherein:
frequency of said local oscillating signal is controllably selected by supplying a frequency word to said phase accumulator of said direct digital synthesizer.

19. A satellite receiver according to claim 1, further comprising:
d) signal analysis circuitry that operates on said combined signal, said signal analysis circuitry comprising a Digital Broadcast Satellite receiver that demodulates and decodes a signal derived from said combined signal to produce at least one video signal for output to a display device in addition to at least one audio signal for output to a speaker.

20. A satellite receiver according to claim 19, wherein:
said signal analysis circuitry includes a radio frequency (RF) transmitter and an RF receiver that communicate said combined signal over a wireless communication link therebetween.

21. A satellite receiver according to claim 19, wherein:
said array of antenna elements, plurality of tuners, summing amplifier, and RF transmitter are disposed on an exterior surface of a vehicle, and said RF receiver and Digital Broadcast Satellite receiver are disposed in the interior of said vehicle.

22. A satellite receiver according to claim 1, further comprising:
d) signal analysis circuitry that operates on said combined signal, said signal analysis circuitry including a demodulator which demodulates a signal derived from said combined signal to produce a digital data stream carrying at least one video signal and at least one audio signal, and a first wireless transceiver that communicates said digital data stream to a second wireless transceiver over a wireless communication link therebetween.

23. A satellite receiver according to claim 22, wherein:
said array of antenna elements, said plurality of tuners, said summing amplifier, said demodulator, and said first wireless transceiver are disposed on an exterior surface of a vehicle, and said second wireless transceiver is disposed in the interior of said vehicle.

24. A satellite receiver according to claim 22, further comprising:
a display device operably coupled to said second wireless transceiver, said display device adapted to display said at least one video signal; and
at least one audio speaker operably coupled to said second wireless transceiver and adapted to play back of said at least one audio signal.

25. A satellite receiver according to claim 71 wherein:
said user channel selection information is communicated from a DBS Receiver to said controller over a wireless communication link therebetween.
